(19) United States
(12) Patent Application Publication
(10) Pub. No.: US 2023/0058559 A1
(43) Pub. Date: Feb. 23, 2023

(54) MOLDED ARTICLES FOR USE WITH TERPENE CONTAINING OILS

(71) Applicant: Eastman Chemical Company, Kingsport, TN (US)

(72) Inventor: Wenlai Feng, Johnson City, TN (US)

(73) Assignee: Eastman Chemical Company, Kingsport, TN (US)

(21) Appl. No.: 17/758,141

(22) PCT Filed: Dec. 30, 2020
(86) PCT No.: PCT/US2020/067410

§ 371 Date: Jun. 29, 2022

Related U.S. Application Data
(60) Provisional application No. 62/956,735, filed on Jan. 3, 2020.

(51) Int. Cl. C08L 1/14

(52) U.S. Cl. CPC C08L 1/14

(57) ABSTRACT

A shaped article comprising a molded component configured to receive a terpene containing oil composition, said molded component formed of a plastic composition comprising cellulose ester and having an HDT of at least 95° C.

### FIELD OF THE INVENTION

This invention belongs to the field of polymer-based resins useful for forming articles or components of articles intended for contact with terpene containing oils. Plastic articles or components for such articles made using these compositions, such as vaporizers, nebulizers, humidifiers, air fresheners, or hand-held vapor delivery devices or components thereof are also provided.

### BACKGROUND OF THE INVENTION

Plastics are a preferred material for making small devices that can be used to deliver a vapor or suspension of a chemical composition based on the relative efficiency of molding parts and articles of various shapes and designs. For example, devices used to deliver/produce a vapor or suspension, such as vaporizers, nebulizers, humidifiers, air fresheners, or hand-held vapor delivery devices, are often manufactured by molding plastic parts that form an assembly to produce the device.

However, when plastics are used in applications where contact with chemicals will occur, there is the potential for cracking, crazing, softening, etc. of the plastic induced by the chemical environment. An especially aggressive class of chemicals is terpene containing oils such as those used for flavoring and fragrance. Many plastics are adversely affected by these chemicals. Thus, there is a need for plastic materials that have resistance to such chemicals, are easily formed into articles, and maintain acceptable physical properties.

It would be beneficial to be able to provide polymer-based resins that can be melt processed and articles made from such compositions that do not have such drawbacks.

### SUMMARY OF THE INVENTION

Surprisingly, it had been discovered that articles molded from certain cellulose ester-based plastics have exceptional resistance to terpene containing oils and maintain sufficient physical properties required for the intended use of the articles. In embodiments, such articles are useful as containers and/or other components in vapor delivery devices that will have significant contact with terpene containing oils in use. In one aspect, articles configured to receive a terpene containing oil composition can be made from compositions of cellulose esters that can be prepared having significant bio-based content and HDTs exceeding 90° C., or 95° C.

In embodiments of the invention, higher HDTs can be achieved by reducing the amount of plasticizer, and in certain embodiments eliminating the use of plasticizer, in the compositions, while maintaining a good balance of physical properties and the ability to process the compositions in conventional molding operations. The elimination/reduction of the plasticizer can also eliminate/diminish problems associated with plasticizer exudation during use and provide sufficiently high HDTs.

It has been discovered that shaped articles configured to receive a terpene containing oil composition can be prepared from bio-based plastic materials that have resistance to the terpene containing oils and have physical properties similar with or better than molded articles produced from oil-based engineering thermoplastics. More specifically, these shaped articles are produced from bio-based plastic material with a heat distortion temperature (HDT) greater than 90° C., or greater than 95° C. This elevated HDT vastly improves the ability of these articles to experience high temperature environments (i.e. dishwashing, holding hot liquids, sun exposure, etc.), resist creep and warpage during hot warehouse storage or during use in applications under moderate load or stress, and prevent loss in dimensional stability during use.

In one aspect of the invention, it is directed to a shaped article configured to receive a terpene containing oil composition and comprising a polymer-based resin derived from cellulose, wherein the polymer-based resin has an HST or at least 90° C., or at least 95° C., a bio-derived content of at least 20 wt %, and has at least one of the following properties chosen from: flexural modulus of greater than 1900 MPa as measured according to ASTM D790 using a 3.2 mm thick bar hat has been subjected to 50% relative humidity for 48 hours at 23° C.; a notched izod impact strength of greater than 80 J/m as measured according to ASTM D256 using a 3.2 mm thick bar that has been subjected to 50% relative humidity for 48 hours at 23° C.; a spiral flow length or at least 3.0 cm, when the polymer-based resin is molded with a spiral flow mold with the conditions of a barrel temperature of 238° C., a melt temperature of 246° C., a molding pressure of 13.8 MPa, a mold thickness of 0.8 mm, and a mold width of 12.7 mm; a flex creep deflection of less than 12 mm, measured using a molded bar having dimensions of 5″ length, 0.5″ width, and 0.125″ thickness positioned horizontally on a fixture with a 4″ span, inside a dry oven for 68 hours at 90° C. with a nominal 500 psi stress on the center of the span; a transmission of at least 70% measured according to ASTM D1003 using a 3.2 mm plague after injection molding at a barrel set point of 249° C. and a residence time of 5 min; a ΔE value of less than 25, using a 3.2 mm plaque after injection molding with a barrel temperature of 249° C. and a residence time of 5 min; or an L* color of at least 85, measured according to ASTM E1348 using a 3.2 mm plague after injection molding with a barrel temperature of 249° C. and a residence time of 5 min. In embodiments, the polymer-based resin has at least 2, or at least 3 of the listed properties. In certain embodiments, the polymer-based resin contains plasticizer in an amount from 1 to 15 wt %, or from 1 to 10 wt %, or from 1 to 9 wt %, or none. In certain embodiments, the polymer-based resin contains less than 5 wt %, or less than 4 wt %, or less than 3 wt %, or less than 2 wt %, or less than 1 wt %, or has no added plasticizer.

In embodiments of the invention, the shaped articles or components thereof can be chosen from injection molded articles, extrusion molded articles, rotational molded articles, compression molded articles, blow molded articles, injection blow molded articles, injection stretch blow molded articles, extrusion blow molded articles, sheet or film extrusion articles, profile extrusion articles, gas assist molding articles, structural foam molded articles, or thermoformed articles.

In embodiments of the invention, the shaped article is chosen from opaque articles, transparent articles, see-through articles, thin-walled articles, technical articles (e.g., articles having a complex design), articles having high design specifications, intricate design articles, containers for holding a terpene containing oil composition, or other shaped articles configured to receive (or contact) a terpene containing oil composition.

In embodiments, the technical articles, articles having high design specifications, and intricate design articles can be chosen from articles that include electrical/electronic components, perfume or cosmetic containers, vapor delivery devices, or components thereof.

In one embodiment of the injection molded article, the polymer-based resin further comprises at least one property chosen from: flexural modulus of greater than 1900 MPa as measured according to ASTM D790 using a 3.2 mm thick bar hat has been subjected to 50% relative humidity for 48 hours at 23° C.; a notched izod impact strength of greater than 80 J/m as measured according to ASTM D256 using a 3.2 mm thick bar hat has been subjected to 50% relative humidity for 48 hours at 23° C.; a flex creep deflection of less than 12 mm, measured using a molded bar having dimensions of 5″ length, 0.5″ width, and 0.125″ thickness positioned horizontally on a fixture with a 4″ span, inside a dry oven for 68 hours at 90° C. with a nominal 500 psi stress on the center of the span; a transmission of at least 70 measured according to ASTM D1003 using a 3.2 mm plaque after injection molding at a barrel set point of 249° C. and a residence time of 5 min; a ΔE value of less than 25, using a 3.2 mm plaque after injection molding with a barrel temperature of 249° C. and a residence time of 5 min; or an L* color of at least 85, measured according to ASTM E1348 using a 3.2 mm plaque after injection molding with a barrel temperature of 249° C. and a residence time of 5 min. In embodiments, the polymer-based resin comprises at least 2, or at least 3 of the listed properties. In embodiments, the polymer-based resin contains less than 5 wt %, or less than 4 wt %, or less than 3 wt %, or less than 2 wt %, or less than 1 wt %, or has no added plasticizer.

In embodiments in accordance with the various aspects of the invention disclosed herein, the polymer-based resin comprises a cellulose ester. In certain embodiments, the cellulose ester is chosen from CA (cellulose acetate), CAP (cellulose acetate propionate), CAB (cellulose acetate butyrate) or CAIB (cellulose acetate isobutyrate), ranging in total degree of substitution from 1.0 to 3.0. In one embodiment, the cellulose ester is CAP. In embodiments of the invention, the CAP contains 0-5 wt %, 0-2 wt %, 0 to less than 2 wt %, 0-1 wt %, or no added plasticizer.

In embodiments of the invention, the polymer-based resin comprises a cellulose ester; and optionally a plasticizer, wherein when the plasticizer is present, the plasticizer is present at less than 20 wt % based on the total weight of the composition, wherein the polymer-based resin has a heat distortion temperature (“HDT”) that is greater than 90° C., or greater than 95° C. according to ASTM D638 as measured at 1.82 MPa using a 1.3 cm×12.7 cm×0.32 cm bar subjected to 50% relative humidity for 4 hours at 70° C., and wherein when the composition is injection molded with a barrel temperature of 260° C. with a residence time of 5 min, the change in the weight average molecular weight (“M_{w}”) is less than 30%.

In certain embodiments, the polymer-based resin comprises a cellulose ester and a dispersion of one or more impact modifiers in the cellulose ester, in the form of small discrete particles in amounts sufficient to improve the mechanical and physical properties of the polymer-based resin, and where the impact modified cellulose ester resin can be melt processed.

In one embodiment of the invention, a polymer-based resin is provided comprising at least one cellulose ester, at least one impact modifier, and optionally, at least one plasticizer. In one embodiment, the cellulose ester is CAP and contains 0-1 wt % plasticizer. In one embodiment, the cellulose ester is CAP and contains no plasticizer.

In another embodiment of the invention, a cellulose ester composition is provided comprising at least one cellulose ester, and at least one impact modifier and at least one plasticizer. In one embodiment, the cellulose ester is CA and contains 1-15 wt % plasticizer. In embodiments, the cellulose ester is CA and contains 1-10 wt %, or 1-less than 10 wt %, or 1-9 wt % plasticizer.

In embodiments, a system for vapor delivery of a terpene containing oil composition is provided that comprises a shaped article configured to receive a terpene containing oil composition and a terpene containing oil composition, wherein the shaped article comprises one or more surfaces in contact with the terpene containing oil composition and/or configured to contact the terpene containing oil composition when the system is used for its intended purpose, and wherein the one or more surfaces are formed from a polymer-based resin derived from cellulose, wherein the polymer-based resin has an HDT or at least 90° C. In embodiments, a majority of the surfaces that are in contact with the terpene containing oil composition and/or configured to contact the terpene containing oil composition when the system is used for its intended purpose are formed from a CAP composition.

In embodiments, the terpene containing oil composition is in the form of a liquid and/or a vapor. In embodiments, the system comprises a shaped article that comprises one or more liquid contact surfaces in contact with a liquid terpene containing oil composition and one or more vapor contact surfaces configured to contact a vapor terpene containing oil composition when the system is used for its intended purpose. In one embodiment, the one or more liquid contact surfaces and the one or more vapor contact surfaces are in fluid communication and the vapor terpene containing oil composition is produced by vaporizing the liquid terpene containing oil composition. In one embodiment, the system comprises a shaped article that comprises one or more surfaces in contact with both a liquid terpene containing oil composition and a vapor terpene containing oil composition.

In embodiments, the system comprises a shaped article that comprises one or more liquid contact surfaces in contact with a liquid terpene containing oil composition for at least 5 minutes. In embodiments, the system comprises a shaped article that comprises one or more vapor contact surfaces in contact with a vapor terpene containing oil composition repetitively for a total contact time of at least 5 minutes.

In embodiments, the terpene containing plant-based oil composition comprises a terpene containing oil that is present in an amount of at least 25 wt %, based on the total weight of the terpene containing oil composition.

### DETAILED DESCRIPTION

In one aspect of the invention, it is directed to a shaped article configured to receive a terpene containing oil composition and comprising a polymer-based resin derived from cellulose, wherein the polymer-based resin has an HDT or at least 90° C., or at least 95° C., a bio-derived content of at least 20 wt %, and has at least one of the following properties chosen from: flexural modulus of greater than 1900 MPa as measured according to ASTM D790 using a 3.2 mm thick bar hat has been subjected to 50% relative humidity for 48 hours at 23° C.; a notched izod impact strength of greater than 80 J/m as measured according to ASTM D256 using a 3.2 mm thick bar hat has been subjected to 50% relative humidity for 48 hours at 23° C.; a spiral flow length or at least 3.0 cm, when the polymer-based resin is molded with a spiral flow mold with the conditions of a barrel temperature of 238° C., a melt temperature of 246° C., a molding pressure of 13.8 MPa, a mold thickness of 0.8 mm, and a mold width of 12.7 mm; a flex creep deflection of less than 12 mm, measured using a molded bar having dimensions of 5″ length, 0.5″ width, and 0.125″ thickness positioned horizontally on a fixture with a 4″ span, inside a dry oven for 68 hours at 90° C. with a nominal 500 psi stress on the center of the span; a transmission of at least 70 measured according to ASTM D1003 using a 3.2 mm plaque after injection molding at a barrel set point of 249° C. and a residence time of 5 min; a ΔE value of less than 25, using a 3.2 mm plaque after injection molding with a barrel temperature of 249° C. and a residence time of 5 min; or an L* color of at least 85, measured according to ASTM E1348 using a 3.2 mm plaque after injection molding with a barrel temperature of 249° C. and a residence time of 5 min. In embodiments, the polymer-based resin has at least 2, or at least 3 of the listed properties. In embodiments, the polymer-based resin contains less than 5 wt %, or less than 4 wt %, or less than 3 wt %, or less than 2 wt %, or less than 1 wt %, or has no added plasticizer.

In certain embodiments, it is directed to a shaped article configured to receive a terpene containing oil composition and comprising a polymer-based resin derived from cellulose, wherein the polymer-based resin has an HDT or at least 90° C., or at least 95° C., a bio-derived content of at least 20 wt %, a notched Izod impact strength of greater than 80 J/m as measured according to ASTM D256 using a 3.2 mm thick bar hat has been subjected to 50% relative humidity for 48 hours at 23° C., and has at least one of the following properties chosen from: flexural modulus of greater than 1900 MPa as measured according to ASTM D790 using a 3.2 mm thick bar hat has been subjected to 50% relative humidity for 48 hours at 23° C.; a spiral flow length or at least 3.0 cm, when the polymer-based resin is molded with a spiral flow mold with the conditions of a barrel temperature of 238° C., a melt temperature of 246° C., a molding pressure of 13.8 MPa, a mold thickness of 0.8 mm, and a mold width of 12.7 mm; a flex creep deflection of less than 12 mm, measured using a molded bar having dimensions of 5″ length, 0.5″ width, and 0.125″ thickness positioned horizontally on a fixture with a 4″ span, inside a dry oven for 68 hours at 90° C. with a nominal 500 psi stress on the center of the span; a transmission of at least 70 measured according to ASTM D1003 using a 3.2 mm plaque after injection molding at a barrel set point of 249° C. and a residence time of 5 min; a ΔE value of less than 25, using a 3.2 mm plaque after injection molding with a barrel temperature of 249° C. and a residence time of 5 min; or an L* color of at least 85, measured according to ASTM E1348 using a 3.2 mm plaque after injection molding with a barrel temperature of 249° C. and a residence time of 5 min. In embodiments, the polymer-based resin has at least 2, or at least 3 of the listed properties. In embodiments, the polymer-based resin contains less than 5 wt %, or less than 4 wt %, or less than 3 wt %, or less than 2 wt %, or less than 1 wt %, or has no added plasticizer.

In embodiments of the invention, the polymer-based resin has a heat distortion temperature (“HDT”) greater than 90° C., or greater than 95° C., according to ASTM D648 as measured at 1.82 MPa using a 3.2 mm thick bar that was subjected to 70° C. for 4 hours. In certain embodiments, the polymer-based resin has a heat distortion temperature (“HDT”) of at least 95° C., at least 100° C., at least 105° C., or at least 110° C., or at least 115° C. In certain embodiments, the polymer-based resin has a heat distortion temperature (“HDT”) in the range from 90° C. to 140° C., 90° C. to 130° C., 90° C. to 120° C., 90° C. to 110° C., 95° C. to 140° C., 95° C. to 130° C., 95° C. to 120° C., 95° C. to 110° C., 95° C. to 105° C., 100° C. to 140° C., 100° C. to 130° C., 100° C. to 120° C., 100° C. to 110° C., 105° C. to 140° C., 105° C. to 130° C., 105° C. to 120° C., 105° C. to 115° C., 105° C. to 110° C., 110° C. to 140° C., 110° C. to 130° C., 110° C. to 125° C., 110° C. to 120° C., 110° C. to 115° C., 115° C. to 140° C., 115° C. to 130° C., 120° C. to 140° C., 120° C. to 130° C., or 120° C. to 125° C.

Bio-sourced products are typically identified through programs such as the USDA's Bio-Preferred program. These programs use ASTM method D6866-16 to measure the percentage of “new carbon” in the plastic material to produce the product. “New carbon” is the carbon that comes from recently grown plants. That is compared with “old carbon” that comes from oil, natural gas or coal. The “new carbon” content in the cellulose based plastics used in the present invention is typically in the range of 40% to 60%, which reflects the fact that the cellulose backbone in the cellulosic material comes from trees or cotton.

In embodiments of the invention, the polymer-based resin has a bio-derived content of at least 20 wt %, measured according to ASTM method D6866-16. In certain embodiments, the polymer-based resin has a bio-derived content of at least 25 wt %, or at least 30 wt %, or at least 35 wt %, or at least 40 wt %, or at least 45 wt %%, measured according to ASTM method D6866-16. In certain embodiments, the polymer-based resin has a bio-derived content in the range of about 20 to about 60 wt %, 20 to 50 wt %, 20 to 45 wt %, 25 to 60 wt %, 25 to 50 wt %, 25 to 45 wt %, 30 to 60 wt %, 30 to 50 wt %, 30 to 45 wt %, 35 to 60 wt %, 35 to 50 wt %, 35 to 45 wt %, 40 to 60 wt %, 40 to 50 wt %, or 40 to 45 wt %%, measured according to ASTM method D6866-16.

In embodiments of the invention, the polymer-based resin has a flexural modulus of greater than 1800 MPa as measured according to ASTM D790 using a 3.2 mm thick bar hat has been subjected to 50% relative humidity for 48 hours at 23° C. In certain embodiments, the polymer-based resin has a flexural modulus of at least 1900 MPa, at least 2000 MPa, at least 2100 MPa, at least 2200 MPa, at least 2300MPa, or at least 2400 MPa, as measured according to ASTM D790 using a 3.2 mm thick bar hat has been subjected to 50% relative humidity for 48 hours at 23° C. In certain embodiments, the polymer-based resin has a flexural modulus is in the range of from about 1800 to about 3500 MPa, from about 1900 to about 3500 MPa, from about 2000 to about 3500 MPa, from about 2100 to about 3500 MPa, from about 2200 to about 3500 MPa, from about 2300 to about 3500 MPa, from about 2400 to about 3500 MPa, or from about 2500 to about 3500 MPa. as measured according to ASTM D790 using a 3.2 mm thick bar hat has been subjected to 50% relative humidity for 48 hours at 23° C. In certain embodiments, the polymer-based resin has a flexural modulus is in the range of from about 1900 to about 2500 MPa, from about 1900 to about 2800 MPa, or from about 1900 to about 3000 MPa, as measured according to ASTM D790 using a 3.2 mm thick bar hat has been subjected to 50% relative humidity for 48 hours at 23° C.

In embodiments of the invention, the polymer-based resin has a notched izod impact strength of at least 40 J/m, or at least 60 J/m, as measured according to ASTM D256 using a 3.2 mm thick bar hat has been subjected to 50% relative humidity for 48 hours at 23° C. In certain embodiments, the polymer-based resin has a notched izod impact strength of at least 80 J/m, at least 90 J/m, or at least 100 J/m, or at least 110 J/m, or at least 120 J/m, or at least 130 J/m, or at least 140 J/m, or at least 150 J/m, as measured according to ASTM D256 using a 3.2 mm thick bar that has been subjected to 50% relative humidity for 48 hours at 23° C. In certain embodiments, the polymer-based resin has a notched izod impact strength in the range of from about 40 J/m to about 400 J/m, from about 40 J/m to about 200 J/m, from about 60 J/m to about 400 J/m, from about 60 J/m to about 200 J/m, from about 80 J/m to about 500 J/m, from about 80 J/m to about 400 J/m, from about 80 J/m to about 300 J/m, from about 80 J/m to about 200 J/m, from 100 J/m to about 500 J/m, from about 100 J/m to about 400 J/m, from about 100 J/m to about 300 J/m, or from about 100 J/m to about 200 J/m. as measured according to ASTM D256 using a 3.2 mm thick bar that has been subjected to 50% relative humidity for 48 hours at 23° C.

In embodiments of the invention, the polymer-based resin has a spiral flow length of at least 3.0 cm, when the polymer-based resin is molded with a spiral flow mold with the conditions of a barrel temperature of 238° C., a melt temperature of 246° C., a molding pressure of 13.8 MPa, a mold thickness of 0.8 mm, and a mold width of 12.7 mm. In certain embodiments, the polymer-based resin has a spiral flow length of at least 4 cm, or at least 5 cm, when the polymer-based resin is molded with a spiral flow mold with the conditions of a barrel temperature of 238° C., a melt temperature of 246° C., a molding pressure of 13.8 MPa, a mold thickness of 0.8 mm, and a mold width of 12.7 mm. In certain embodiments, the polymer-based resin has a spiral flow length mold in the range from about 3.0 cm to about 10.0 cm, from about 4.0 cm to about 10.0 cm, from about 5.0 cm to about 10.0 cm, from about 4.0 cm to about 9.0 cm, from about 4.0 cm to about 8.0 cm, from about 4.0 cm to about 7.0 cm, or from about 5.0 cm to about 7.0 cm, when the polymer-based resin is molded with a spiral flow mold with the conditions of a barrel temperature of 238° C., a melt temperature of 246° C., a molding pressure of 13.8 MPa, a mold thickness of 0.8 mm, and a mold width of 12.7 mm.

In embodiments of the invention, the polymer-based resin has a flex creep deflection of less than 12 mm, or less than 11 mm, or less than 10 mm, after exposure for 68 hours inside an oven at 90° C. and tested in accordance with ASTM D2990 using an injection molded bar having dimensions of 5″ length, 0.5″ width, and 0.125″ thickness positioned horizontally on a fixture with a 4″ span, with a nominal 500 psi stress on the center of the span. In certain embodiments, the polymer-based resin has a flex creep deflection in the range from 2 to 12 mm, or 2 to 11 mm, or 2 to 10 mm, or 5 to 10 mm, after exposure for 68 hours inside an oven at 90° C. measured using an injection molded bar having dimensions of 5″ length, 0.5″ width, and 0.125″ thickness positioned horizontally on a fixture with a 4″ span, with a nominal 500 psi stress on the center of the span.

In embodiments of the invention, the polymer-based resin has a ΔE value of less than 25, or less than 20, or less than 15, or less than 14, or less than 13, or less than 12, or less than 11, or less than 10, or less than 9, or less than 8, or less than 7, or less than 6, or less than 5, using a 3.2 mm plaque after injection molding with a barrel temperature of 249° C. and a residence time of 5 min, wherein ΔE is determined by the following equation: ((L*−100)²+(a*−0)²+(b*−0)²)^{1/2}, where the L*, a*, and b* color components were measured according to ASTM E1348. In certain embodiments, the polymer-based resin has a ΔE value in the range from 2 to 25, or from 2 to 20, or from 2 to 15, or from 2 to 14, or from 2 to 13, or from 2 to 12, or from 2 to 11, or from 2 to 10, or from 2 to 9, or from 2 to 8, or from 2 to 7, or from 2 to 6, or from 2 to 5, using a 3.2 mm plaque after injection molding with a barrel temperature of 249° C. and a residence time of 5 min, wherein ΔE is determined by the following equation: ((L*−100)²+(a*−0)²+(b*−0)²)^{1/2}, where the L*, a*, and b* color components were measured according to ASTM E1348.

In embodiments of the invention, the polymer-based resin has an L* color of at least 85, or at least 86, or at least 87, or at least 88, or at least 89, or at least 90, or at least 91, or at least 92, or at least 93, or at least 94, or at least 95, measured according to ASTM E1348 using a 3.2 mm plaque after injection molding with a barrel temperature of 249° C. and a residence time of 5 min. In certain embodiments, the polymer-based resin has an L* color in the range from 85 to 98, or from 85 to 97, or from 85 to 96, or from 85 to 95, measured according to ASTM E1348 using a 3.2 mm plaque after injection molding with a barrel temperature of 249° C. and a residence time of 5 min.

In embodiments of the invention, the polymer-based resin has a b* value is less than 15, or less than 12, or less than 10, or less than 9, or less than 8, or less than 7, or less than 6, or less than 5, or less than 4, measured according to ASTM E1348 using a 3.2 mm plaque after injection molding with a barrel temperature of 249° C. and a residence time of 5 min. In certain embodiments, the polymer-based resin has a b* color in the range from 0 to 15, or from 0 to 10, or from 0 to 8, or from 0 to 5, measured according to ASTM E1348 using a 3.2 mm plaque after injection molding with a barrel temperature of 249° C. and a residence time of 5 min.

In embodiments of the invention, the polymer-based resin has a change in the absolute weight average molecular weight (“M_{w}”) due to injection molding of less than 30%, or less than 25%, or less than 20%, or less than 15%, or less than 10%, when the composition is injection molded with a barrel temperature of 260° C. with a residence time of 5 min. In certain embodiments, the polymer-based resin has a change in the absolute weight average molecular weight (“M_{w}”) due to injection molding in the range of 0 to 30%, or 0 to 25%, or 0 to 20%, or 0 to 15%, or 0 to 10%, or 2 to 30%, or 2 to 25%, or 2 to 20%, or 2 to 15%, or 2 to 10%, when the composition is injection molded with a barrel temperature of 260° C. with a residence time of 5 min.

In embodiments of the invention, the polymer-based resin comprises a cellulose ester which has an absolute weight average molecular weight in the range of from about 40,000 Da to about 200,000 Da measured according to ASTM D5296 using tetrahydrofuran as a solvent and a flow rate of 1 mL/min. In certain embodiments, the cellulose ester has an absolute weight average molecular weight in the range of from about 50,000 Da to about 200,000 Da, or 50,000 Da to about 170,000 Da, or 50,000 Da to about 120,000 Da, or 50,000 Da to about 90,000 Da, or 60,000 Da to about 200,000 Da, or 60,000 Da to about 170,000 Da, or 60,000 Da to about 120,000 Da, or 60,000 Da to about 90,000 Da, or 90,000 Da to about 170,000 Da, or 90,000 Da to about 120,000 Da, or 120,000 Da to about 170,000 Da, or 120,000 Da to about 200,000 Da, measured according to ASTM D5296 using tetrahydrofuran as a solvent and a flow rate of 1 mL/min.

In aspects of this invention, it is directed to shaped articles. In certain embodiments, the shaped articles are not continuously extruded films that are infinite (or continuous) in one direction and fixed in width and thickness in the other two directions, as would be the case in a rolled film. In certain embodiments, a film or sheet can be converted into a shaped article, e.g., by thermoforming into a three-dimensional object, such as a cup or bowl. In embodiments of the invention, the shaped article is not a film or is not a sheet. In embodiments of the invention, the shaped articles can be chosen from injection molded articles, extrusion molded articles, rotational molded articles, compression molded articles, blow molded articles, injection blow molded articles, injection stretch blow molded articles, extrusion blow molded articles, sheet or film extrusion articles, profile extrusion articles, gas assist molding articles, structural foam molded articles, or thermoformed articles.

Shaped articles made from polymer-based resins according to the present invention can be shaped via molding or extruding for use in vapor delivery applications. In embodiments of the invention, the shaped article is chosen from transparent articles, see-through articles, thin-walled articles, technical articles (e.g., articles having a complex design), articles having high design specifications, intricate design articles, containers, food contact articles, household articles, general consumer products, packaging articles, medical articles, or components thereof, where the article is configure to receive a terpene containing oil composition.

In certain embodiments, the polymer-based resins can be primary molded into forms such as pellets, plates, or parisons, and can then be secondary molded into articles, e.g., conduits, tubes, thin-wall vessels, or thick-wall vessels, configured to receive a terpene containing oil composition.

The methods of forming the cellulose ester compositions into films, molded articles, and sheeting can be according to methods known in the art.

As discussed herein, in certain embodiments of the invention, the polymer-based resins comprise at least one cellulose ester.

In embodiments, the cellulose ester utilized in this invention can be any that is known in the art. Cellulose esters that can be used for the present invention generally comprise repeating units of the structure:

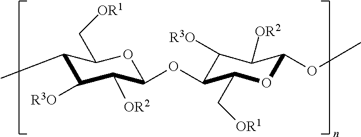

wherein R¹, R², and R³ are selected independently from the group consisting of hydrogen or straight chain alkanoyl having from 2 to 10 carbon atoms. For cellulose esters, the substitution level is usually expressed in terms of degree of substitution (DS), which is the average number of non-OH substituents per anhydroglucose unit (AGU). Generally, conventional cellulose contains three hydroxyl groups in each AGU unit that can be substituted; therefore, DS can have a value between zero and three. However, low molecular weight cellulose mixed esters can have a total degree of substitution slightly above 3, due to end group contributions. Native cellulose is a large polysaccharide with a degree of polymerization from 250-5,000 even after pulping and purification, and thus the assumption that the maximum DS is 3.0 is approximately correct. However, as the degree of polymerization is lowered, as in low molecular weight cellulose mixed esters, the end groups of the polysaccharide backbone become relatively more significant, thereby resulting in a DS that can range in excess of 3.0. Low molecular weight cellulose mixed esters are discussed in more detail subsequently in this disclosure. Because DS is a statistical mean value, a value of 1 does not assure that every AGU has a single substitutent. In some cases, there can be unsubstituted anhydroglucose units, some with two and some with three substitutents, and typically the value will be a non-integer. Total DS is defined as the average number of all of substituents per anhydroglucose unit. The degree of substitution per AGU can also refer to a particular substitutent, such as, for example, hydroxyl, acetyl, butyryl, or propionyl. In embodiments, the degree of polymerization for the cellulose ester is lower than that of the native cellulose. In embodiments, n is an integer in a range from 25 to 250, or 25 to 200, or 25 to 150, or 25 to 100, or 25 to 75.

In embodiments, the cellulose ester utilized can be a cellulose triester or a secondary cellulose ester. Examples of cellulose triesters include, but are not limited to, cellulose triacetate, cellulose tripropionate, or cellulose tributyrate. Examples of secondary cellulose esters include cellulose acetate, cellulose acetate propionate, and cellulose acetate butyrate.

In one embodiment of the invention, the cellulose ester can be chosen from cellulose acetate (CA), cellulose propionate (CP), cellulose butyrate (CB), cellulose acetate propionate (CAP), cellulose acetate butyrate (CAB), cellulose propionate butyrate (CPB), and the like, or combinations thereof. Examples of such cellulose esters are described in U.S. Pat. Nos. 1,698,049; 1,683,347; 1,880,808; 1,880,560; 1,984,147, 2,129,052; and 3,617,201, incorporated herein by reference in their entirety to the extent that they do not contradict the statements herein.

In embodiments of the invention, the cellulose esters have at least 2 anhydroglucose rings and can have between at least 50 and up to 5,000 anhydroglucose rings. The number of anhydroglucose units per molecule is defined as the degree of polymerization (DP) of the cellulose ester. In embodiments, cellulose esters can have an inherent viscosity (IV) of about 0.2 to about 3.0 deciliters/gram, or about 0.5 to about 1.8, or about 1 to about 1.5, as measured at a temperature of 25° C. for a 0.25 gram sample in 100 ml of a 60/40 by weight solution of phenol/tetrachloroethane. Examples of cellulose esters include, but are not limited to, cellulose acetate, cellulose propionate, cellulose butyrate, cellulose acetate propionate (CAP), cellulose acetate butyrate (CAB), cellulose propionate butyrate, and the like. In embodiments, cellulose esters useful herein can have a DS/AGU of about 2 to about 2.99, and the substituting ester can comprise either acetyl, propionyl and butyryl, or any combinations of these. In another embodiment of the invention, the total DS/AGU ranges from about 2 to about 2.99 and the DS/AGU of acetyl ranges from about 0 to 2.2, with the remainder of the ester groups comprising propionyl, butyryl or combinations thereof.

Cellulose esters can be produced by any method known in the art. Examples of processes for producing cellulose esters are taught in Kirk-Othmer, Encyclopedia of Chemical Technology, 5^{th} Edition, Vol. 5, Wiley-Interscience, New York (2004), pp. 394-444. Cellulose, the starting material for producing cellulose esters, can be obtained in different grades and sources such as from cotton linters, softwood pulp, hardwood pulp, corn fiber and other agricultural sources, and bacterial cellulose, among others.

One method of producing cellulose esters is esterification of the cellulose by mixing cellulose with the appropriate organic acids, acid anhydrides, and catalysts. Cellulose is then converted to a cellulose triester. Ester hydrolysis is then performed by adding a water-acid mixture to the cellulose triester, which can then be filtered to remove any gel particles or fibers. Water is then added to the mixture to precipitate the cellulose ester. The cellulose ester can then be washed with water to remove reaction by-products followed by dewatering and drying.

The cellulose triesters to be hydrolyzed can have three substitutents selected independently from alkanoyls having from 2 to 10 carbon atoms. Examples of cellulose triesters include cellulose triacetate, cellulose tripropionate, and cellulose tributyrate or mixed triesters of cellulose such as cellulose acetate propionate, and cellulose acetate butyrate. These cellulose esters can be prepared by a number of methods known to those skilled in the art. For example, cellulose esters can be prepared by heterogeneous acylation of cellulose in a mixture of carboxylic acid and anhydride in the presence of a catalyst such as H₂SO₄. Cellulose triesters can also be prepared by the homogeneous acylation of cellulose dissolved in an appropriate solvent such as LiCl/DMAc or LiCl/NMP.

Those skilled in the art will understand that the commercial term of cellulose triesters also encompasses cellulose esters that are not completely substituted with acyl groups. For example, cellulose triacetate commercially available from Eastman Chemical Company, Kingsport, Tenn., U.S.A., typically has a DS from about 2.85 to about 2.99.

After esterification of the cellulose to the triester, part of the acyl substitutents can be removed by hydrolysis or by alcoholysis to give a secondary cellulose ester. As noted previously, depending on the particular method employed, the distribution of the acyl substituents can be random or non-random. Secondary cellulose esters can also be prepared directly with no hydrolysis by using a limiting amount of acylating reagent. This process is particularly useful when the reaction is conducted in a solvent that will dissolve cellulose. All of these methods yield cellulose esters that are useful in this invention.

In one embodiment, the secondary cellulose esters useful in the present invention have an absolute weight average molecular weight (Mw) from about 5,000 to about 400,000 as measured by gel permeation chromatography (GPC) according to ASTM D6474. The following method is used to calculate the absolute weight average molecular weight values (Mw) for CE. The solvent is THF stabilized with BHT Preservative. The instrumentation for the THF/cellulose ester procedure consists of the following Agilent 1200 series components: degasser, isocratic pump, auto-sampler, column oven, UV/Vis detector and a refractive index detector. The test temperature is 30° C. and flow rate is 1.0 ml/min. A sample solution of 25 mg cellulose ester in 10 ml THF with BHT preservative and 10 μl toluene flow rate marker is made. The injection volume is 50 μl. The column set is Polymer Laboratories 5 μm PLgel, Guard+Mixed C+Oligopore. The detection is by refractive index. The calibrants are monodisperse polystyrene standards, Mw=580 to 3,220,000 from Polymer Laboratories. The universal calibration parameters are as follows: PS (K=0.0001280 and a=0.7120) and CE (K=0.00007572 and a=0.8424). The universal calibration parameters above were determined by light scattering and viscometery to yield the correct weight average molecular weights. In a further embodiment, the Mw is from about 15,000 to about 300,000. In yet further embodiments, the Mw ranges from about 10,000 to about 250,000; from about 15000 to 200000; from about 20,000 to about 150,000; from about 50,000 to about 150,000, or from about 70,000 to about 120,000.

The most common commercial secondary cellulose esters are prepared by initial acid catalyzed heterogeneous acylation of cellulose to form the cellulose triester. After a homogeneous solution in the corresponding carboxylic acid of the cellulose triester is obtained, the cellulose triester is then subjected to hydrolysis until the desired degree of substitution is obtained. After isolation, a random secondary cellulose ester is obtained. That is, the relative degree of substitution (RDS) at each hydroxyl is roughly equal.

Some examples of cellulose esters that can be useful in the present invention can be prepared using techniques known in the art and can be obtained from Eastman Chemical Company, Kingsport, Tenn., U.S.A., e.g., Eastman™ Cellulose Acetate Propionate CAP 482-20, Eastman™ Cellulose Acetate Propionate CAP 141-20, Eastman™ Cellulose Acetate Butyrate CAB 381-20, Cellulose Acetate Butyrate CAB 171-15 and Eastman™ Cellulose Acetate CA 398-30.

In embodiments, the cellulose esters utilized in this invention can also contain chemical functionality and are described herein as either derivatized, modified, or functionalized cellulose esters. Functionalized cellulose esters can be produced by reacting the free hydroxyl groups of cellulose esters with a bifunctional reactant that has one linking group for grafting to the cellulose ester and one functional group to provide a new chemical group to the cellulose ester. Examples of such bifunctional reactants include succinic anhydride which links through an ester bond and provides acid functionality; mercaptosilanes which links through alkoxysilane bonds and provides mercapto functionality; and isocyanotoethyl methacrylate which links through a urethane bond and gives methacrylate functionality.

In one embodiment of the invention, functionalized cellulose esters are produced by reacting the free hydroxyl groups of the cellulose esters with a bifunctional reactant producing a cellulose ester with at least one functional group selected from the group consisting of un saturation (double bonds), carboxylic acids, acetoacetate, acetoacetate imide, mercapto, melamine, and long alkyl chains.

In one embodiment of the invention, the cellulose ester can be chosen from cellulose propionate (CP), cellulose butyrate (CB), cellulose acetate propionate (CAP), cellulose acetate butyrate (CAB), cellulose propionate butyrate (CPB), cellulose tripropionate (CTP), or cellulose tributyrate (CTB), but not from cellulose acetate (CA).

In embodiments, the polymer-based resin in accordance with the invention comprises a cellulose ester; and optionally a plasticizer, wherein when the plasticizer is present, the plasticizer is present at less than 20 wt % based on the total weight of the resin, wherein the resin has a heat distortion temperature that is in the range of from about 90° C. to about 140° C. according to ASTM D648 as measured at 1.82 MPa using a 3.2 mm thick bar subjected to 70° C. for 4 hours, and wherein the change in the weight average molecular weight (“M_{w}”) due to injection molding is less than 30%, when the resin is injection molded with a barrel temperature of 260° C. with a residence time of 5 min.

In certain embodiments, where the polymer-based resin is a cellulose ester composition, the change in the weight average molecular weight (“M_{w}”) due to injection molding is less than 25%, or less than 20%, or less than 15%, or less than 10%, when the resin is injection molded with a barrel temperature of 260° C. with a residence time of 5 min. In certain embodiments, the change in the weight average molecular weight (“M_{w}”) due to injection molding is in the range from 0 to 25%, or from 0 to 20%, or from 0 to 15%, or from 0 to 10%, when the resin is injection molded with a barrel temperature of 260° C. with a residence time of 5 min.

In embodiments, a salt stabilizer can be incorporated into the cellulose ester composition to stabilize the cellulose ester composition during processing. The cation component of the salt stabilizer is chosen from aluminum, calcium, magnesium, copper, cobalt, manganese, barium, strontium, zinc, tin, cadmium, chromium and iron cations; and the anion component of the salt stabilizer is an (C₆₋₂₀)alicyclic carboxylic acid, a (C₆₋₂₀)alkyl carboxylic acid, or a (C₆₋₂₀)alkenyl carboxylic acid, Examples of the (C₆₋₂₀)alicyclic carboxylic acid, the (C₆₋₂₀)alkyl carboxylic acid, or the (C₆₋₂₀)alkenyl carboxylic acid include naphthenic acid, abietic acid, cyclohexane carboxylic acid, cyclohexane propionic acid, 3-methyl-cyclopentyl acetic acid, 4-methylcyclohexane carboxylic acid, 2,2,6-trimethylcyclohexane carboxylic acid, 2,3-dimethylcyclopentyl acetic acid, 2-methylcyclopentyl propionic acid, palmitic acid, stearic acid, oleic acid, lauric acid, and the like. Examples of the salt stabilizers include strontium naphthenate, copper naphthenate, magnesium naphthenate, copper abietate, magnesium abietate, and the like.

In one embodiment, the cellulose ester composition further comprises a salt stabilizer in the range of from about 0.01 wt % to about 0.5 wt % based on the total weight of the composition. In one embodiment, the cellulose ester composition further comprises a salt stabilizer in the range of from about 0.01 wt % to about 0.4 wt % based on the total weight of the composition. In one embodiment, the cellulose ester composition further comprises a salt stabilizer in the range of from about 0.01 wt % to about 0.3 wt % based on the total weight of the composition. In one embodiment, the cellulose ester composition further comprises a salt stabilizer in the range of from about 0.01 wt % to about 0.2 wt % based on the total weight of the composition. In one embodiment, the cellulose ester composition further comprises a salt stabilizer in the range of from about 0.1 wt % to about 0.3 wt % based on the total weight of the composition. In one embodiment, the cellulose ester composition further comprises a salt stabilizer in the range of from about 0.01 wt % to about 0.1 wt % based on the total weight of the composition.

In embodiments of the invention, the polymer-based resin, e.g., where the polymer-based resin is a cellulose ester composition, can comprise antioxidants and acid stabilizers. Antioxidants are chemicals used to interrupt degradation processes during the processing of materials. Antioxidants are classified into several classes, including primary antioxidant, and secondary antioxidant.

“Primary antioxidants” are antioxidants that act by reacting with peroxide radicals via a hydrogen transfer to quench the radicals. Primary antioxidants generally contain reactive hydroxy or amino groups such as in hindered phenols and secondary aromatic amines. Examples of primary antioxidants include Irganox™ 1010, 1076, 1726, 245, 1098, 259, and 1425; Ethanox™ 310, 376, 314, and 330; Evernox™ 10, 76, 1335, 1330, 3114, MD 1024, 1098, 1726, 120. 2246, and 565; Anox™ 20, 29, 330, 70, IC-14, and 1315; Lowinox™ 520, 1790, 22IB46, 22M46, 44B25, AH25, GP45, CA22, CPL, HD98, TBPA-6, and WSP; Naugard™ 431, PS48, SP, and 445; Songnox™ 1010, 1024, 1035, 1076 CP, 1135 LQ, 1290 PW, 1330FF, 1330PW, 2590 PW, and 3114 FF; and ADK Stab AO-20, AO-30, AO-40, AO-50, AO-60, AO-80 and AO-330.

In one embodiment, the composition further comprises a primary antioxidant in the range of from 0 to about 1.0 wt % based on the total weight of the composition. In certain embodiments, the composition further comprises a primary antioxidant in the range of from about 0.1 to about 1.0 wt %, or from about 0.2 to about 1.0 wt %, or from about 0.3 to about 1.0 wt %, or about 0.4 to about 1.0 wt %, or from about 0.5 to about 1.0 wt %, or from about 0.6 to about 1.0 wt %, or from about 0.7 to about 1.0 wt %, or from about 0.8 to about 1.0 wt %, based on the total weight of the composition. In certain embodiments, the composition further comprises a primary antioxidant in the range of from about 0.1 to about 0.8 wt %, or from about 0.1 to about 0.6 wt %, or from about 0.1 to about 0.4 wt %, based on the total weight of the composition.

“Secondary antioxidants” are often called hydroperoxide decomposers. They act by reacting with hydroperoxides to decompose them into nonreactive and thermally stable products that are not radicals. They are often used in conjunction with primary antioxidants. Examples of secondary antioxidants include the organophosphorous (e.g., phosphites, phosphonites) and organosulfur classes of compounds. The phosphorous and sulfur atoms of these compounds react with peroxides to convert the peroxides into alcohols. Examples of secondary antioxidants include Ultranox 626, Ethanox™ 368, 326, and 327; Doverphos™ LPG11, LPG12, DP S-680, 4, 10, S480, and S-9228; Evernox™ 168 and 626; Irgafos™ 126 and 168; Weston™ DPDP, DPP, EHDP, PDDP, TDP, TLP, and TPP; Mark™ CH 302, CH 55, TNPP, CH66, CH 300, CH 301, CH 302, CH 304, and CH 305; ADK Stab 2112, HP-10, PEP-8, PEP-36, 1178, 135A, 1500, 3010, C, and TPP; Weston 439, DHOP, DPDP, DPP, DPTDP, EHDP, PDDP, PNPG, PTP, PTP, TDP, TLP, TPP, 398, 399, 430, 705, 705T, TLTTP, and TNPP; Alkanox 240, 626, 626A, 627AV, 618F, and 619F; and Songnox™ 1680 FF, 1680 PW, and 6280 FF.

In embodiments, the composition further comprises a secondary antioxidant in the range of from about 0.1 to about 0.8 wt %, or from about 0.2 to about 0.8 wt %, or from about 0.3 to about 0.8 wt %, or from about 0.4 to about 0.8 wt %, or from about 0.5 to about 0.8 wt %, or from about 0.6 to about 0.8 wt %, based on the total weight of the composition. In certain embodiments, the composition further comprises a secondary antioxidant in the range of from about 0.1 to about 0.7 wt %, or from about 0.1 to about 0.6 wt %, or from about 0.1 to about 0.5 wt %, or from about 0.1 to about 0.4 wt %, or from about 0.1 to about 0.3 wt %, based on the total weight of the composition. In certain embodiment, the composition further comprises a secondary antioxidant in the range of from about 0.3 to about 0.7 wt %, or from about 0.3 to about 0.6 wt %, based on the total weight of the composition.

“Acid scavengers” are additives that neutralize acids formed during the processing of polymers. Examples of acid scavengers include Hycite 713; Kisuma DHT-4A, DHT-4V, DHT-4A-2, DHT-4C, ZHT-4V, and KW2200; Brueggemann Chemical Zinc Carbonate RAC; Sipax™ AC-207; calcium stearate; Baerlocher GL 34, RSN, GP, and LA Veg; Licomont CAV 102; FACI Calcium Stearate DW, PLC, SP, and WLC; Hangzhou Hitech Fine Chemical: CAST, and ZnST; Songstab™ SC-110, SC-120, SC-130, SM-310, and SZ-210; Sun Ace SAK-CS, SAK-DSC, SAK-DMS, SAK-DZS, and SAK-KS; US Zinc Oxide 201, 205 HAS, 205H, 210, and 210E; Drapex™ 4.4, 6.8, 39, 391, 392, and 392S; Vikoflex™ 4050, 5075, 7170, 7190, 7040, 9010, 9040, and 9080; Joncryl™ ADR 4468, and ADR 4400; Adeka CIZER D-32; Epon™ 1001F, 1002F, and 1007F; Aralidite™ ECN 1299, 1273, 1280, 1299, and 9511; Dynamar RC 5251Q; and Nexamite PBO.

In embodiments, the composition further comprises an acid scavenger in the range of from about 0.2 to about 2.0 wt %, or from about 0.4 to about 2.0 wt %, or from about 0.6 to about 2.0 wt %, or from about 0.8 to about 2.0 wt %, or from about 1.0 to about 2.0 wt %, or from about 1.2 to about 2.0 wt %, or from about 1.4 to about 2.0 wt %, or from about 1.6 to about 2.0 wt %, or from about 1.8 to about 2.0 wt %, based on the total weight of the composition. In certain embodiments, the composition further comprises an acid scavenger in the range of from about 0.2 to about 1.8 wt %, or from about 0.2 to about 1.6 wt %, or from about 0.2 to about 1.4 wt %, or from about 0.2 to about 1.2 wt %, or from about 0.2 to about 1.0 wt %, or from about 0.2 to about 0.8 wt %, or from about 0.2 to about 0.6 wt %, or from about 0.2 to about 0.4 wt %, based on the total weight of the composition. In certain embodiments, the composition further comprises an acid scavenger in the range of from about 0.4 to about 1.8 wt %, or from about 0.6 to about 1.6 wt %, or from about 0.8 to about 1.4 wt %, or from about 0.8 to about 1.2 wt %, based on the total weight of the composition.

In one embodiment, the composition further comprises a secondary antioxidant in the range of from about 0.1 to about 0.8 wt % based on the total weight of the composition; and an acid scavenger in the range of from about 0.2 to about 2.0 wt % based on the total weight of the composition.

In one embodiment, the composition further comprises a primary antioxidant in the range of from about 0 to about 1.0 wt % based on the total weight of the composition; a secondary antioxidant in the range of from about 0.1 to about 0.8 wt % based on the total weight of the composition; and an acid scavenger in the range of from about 0.2 to about 2.0 wt % based on the total weight of the composition.

In one embodiment, the composition further comprises a secondary antioxidant in the range of from about 0.1 to about 0.8 wt % based on the total weight of the composition; an acid scavenger in the range of from about 0.2 to about 2.0 wt % based on the total weight of the composition; and an impact modifier in the range of from 0 to about 15 wt % based on the total weight of the composition.

In one embodiment, the composition further comprises a primary antioxidant in the range of from about 0 to about 1.0 wt % based on the total weight of the composition; a secondary antioxidant in the range of from about 0.1 to about 0.8 wt % based on the total weight of the composition; an acid scavenger in the range of from about 0.2 to about 2.0 wt % based on the total weight of the composition; and an impact modifier in the range of from 0 to about 15 wt % based on the total weight of the composition.

In embodiments of the invention, the impact modifier can be any material found to increase the impact strength of cellulose ester compositions. For purposes of this invention, an impact modifier is defined as any material in which at least one portion of its composition is an elastomer with a glass transition temperature (Tg) below room temperature. Tg can be measured for example according to ASTM D3418 using a TA 2100 Thermal Analyst Instrument using a scan rate of 20° C./min. Several classes of impact modifier fit this description. In one embodiment, the composition further comprises an impact modifier in the range of from 0 to about 15 wt % based on the total weight of the composition.

In one embodiment, the impact modifier can be selected from the class of materials known as modified polyolefins. In this class, the olefin is copolymerized with additional monomers that limit the crystallization of the polymer and increase the amount of the chain with Tg below room temperature and reduce the modulus below 500 MPa. Examples of modified olefins include EMA (examples include Elvaloy 4051, Lotader 3410 and Lotader 8900), EBA, EVA (examples include Levamelt 500, Levamelt 600, Levamelt 700, Levamelt 800, Elvax 40W, Evatane 28-40, Evatane 40-55, Evatane 18-150, Bynel E418 and Bynel 3101), EEA, EPDM (examples include Royaltuf 498), EPR, etc.

In one class of the embodiment, the impact modifier is a block copolymer in which at least one segment of the chain has a Tg below room temperature, referred to as the soft segment, and at least one segment of the chain has a Tg or Tm above room temperature, referred to as the hard segment. These block copolymers are also commonly referred to as thermoplastic elastomers (TPEs). Examples of block copolymers of this class include styrenic materials such as SBS, SEBS, and SIS (examples include Kraton G1657MS, Kraton FG1901 G and Kraton FG1924 G); thermoplastic urethanes (TPU) (examples include Elastolan 1170Z, Estane 2355, Estane ALR CL87A and Estane ALR 72A); polyester-ether copolymers (examples include Ecdel 9966 and Hytrel 3078) or polyamide-ether copolymers (examples include Pebax 5533).

In one embodiment, the impact modifier can be selected from the class of emulsion-prepared materials known as core-shell impact modifiers. In one embodiment, the impact modifier is a MBS core-shell impact modifier such as a methacrylate-butadiene-styrene that has a core made out of butadiene-styrene copolymers and shell made out of methyl methacrylate-styrene copolymer. In another embodiment, the impact modifier is an acrylic core-shell impact modifier that has a core made out of an acrylic polymer and shell from made from polymethylmethacrylate, such as methyl methacrylate-butyl acrylate.

In one embodiment of the invention, the core shell impact modifier is an MBS impact modifier that can comprise:
(A) from about 70 to about 85 parts of a core comprising from about 15 to about 35 percent by weight of units derived from at least one vinyl aromatic monomer, and from about 65 to about 85 percent by weight of units derived from at least one diolefin monomer;
(B) from about 8 to about 14 parts of an inner graft stage comprising at least one vinyl aromatic monomer or at least one C1-C4 alkyl methacrylate monomer;
(C) from about 0.1 to about 5 parts of an intermediate sealer stage comprising at least one monomer selected from a C1-C8 alkyl acrylate or a polyunsaturated crosslinker; and
(D) from about 10 to about 16 parts of an outer shell comprising at least one C1-C4 alkyl (meth)acrylate monomers or at least one vinyl aromatic monomer.

In embodiments, the MBS impact modifier can comprise graft polymer compositions comprising 10 to 70 percent by weight of a polymer or a copolymer of butadiene and grafts of firstly methyl(meth)acrylate and cross-linker, and secondly of styrene, and thirdly of methyl(meth)acrylate with an optional cross-linker.

Monomers suitable for polymerization with the conjugated diolefin and preferably with butadiene, can include alkenyl aromatic compounds and preferably vinyl aromatic compounds such as styrene, divinylbenzene, alpha-methyl styrene, vinyl toluene, hydrogenated styrene; lower (CZ-Cu) alkyl acrylates such as ethyl acrylate, n-propylacrylate, n-butyl acrylate, Z-methylbutylacrylate, 3-methylbutyl acrylate, amylacrylate, n-hexylacrylate, Z-ethylhexyl acrylate; lower (C2-C12) alkyl(meth)acrylates; acrylonitriles; olefins; and the like; or a combination of any of the foregoing.

Suitable cross-linking agents include divinylbenzene; di(meth)acrylates; diacrylates such as the diacrylate of mono-, di- or polyethylene glycol; their (meth)acrylates; divinyl sulfide; divinyl ether; vinyl acrylate; vinyl(meth)acrylate; trivinylbenzene; trimethylolpropane; tri(meth)acrylate; triallyl cyanurate and triallyl isocyanurate.

In one embodiment, the MBS core-shell impact modifier can comprise a copolymer of butadiene and styrene or a terpolymer of butadiene, styrene, and divinylbenzene. Although the relative amounts of the monomers which comprise the copolymeric substrate may vary, the butadiene component will typically comprise from about 30 to 100 parts by weight, the styrene component can comprise from 0 to about 70 parts by weight, and the divinylbenzene component can comprise from 0 to about 5 parts by weight based upon 100 parts by weight of butadiene, styrene, and divinylbenzene combined. In an embodiment, the copolymer substrate can comprise from about 50 to about 90 parts by weight of butadiene, from about 10 to about 50 parts by weight of styrene, and from 0 to about 5 parts by weight of divinylbenzene on the same basis, or from about 65 to about 85 parts by weight of butadiene, from about 15 to about 35 parts by weight of styrene, and from about 0.5 to about 2.0 parts by weight of divinylbenzene on the same basis.

Examples of methacrylate-butadiene-styrene core shell polymers are those described in, but not limited to, U.S. Pat. Nos. 4,446,585, 5,534,594, and 6,331,580. MBS core-shell impact modifiers can be obtained as Kane Ace B564 from Kaneka, Clearstrength from Arkema, Paraloid from Dow, and Visiomer from Evonik.

In one class of this embodiment, the impact modifier is an ABS core-shell impact modifier. Examples of ABS core-shell impact modifiers include an acrylonitrile-butadiene-styrene ABS core-shell impact modifier that has a core made out of butadiene-styrene copolymers and shell made out of acrylonitrile-styrene copolymer.

In one embodiment of the present invention, the core shell impact modifier is an acrylic impact modifier comprising about 25 to 95 weight percent of a first elastomeric phase polymerized from a monomer system comprising about 75 to 99.8 percent by weight of a (C1 to C6) alkyl acrylate, 0.1 to 5 percent by weight cross-linking monomer, and 0.1 to 5 percent by weight graft linking monomer, and about 75 to 5 weight percent of a final, rigid thermoplastic phase free of epoxy groups polymerized in the presence of said elastomeric phase.

Examples of useful acrylates are methyl acrylate, ethyl acrylate, butyl acrylate, 2-ethylhexyl acrylate and the like. In some embodiments, the acrylates are n-butyl acrylate and ethyl acrylate.

Examples of acrylic core shell polymers are those described in, but not limited to, U.S. Pat. Nos. 3,448,173, 3,655,825, and 3,853,968. Examples of suitable acrylic impact modifiers are Kane Ace ECO100 from Kaneka, Durastrength from Arkema, Elvaloy and Elvaloy HP from DuPont, and Paraloid from Dow.

In one embodiment, the impact modifier has a relatively neutral pH (e.g., pH between 6 and 8, preferably between 6.5 and 7.5). It is believed that this will help prevent the cellulose esters from degrading during the melt processing of the compositions.

In another embodiment, the refractive index (RI) of the impact modifiers is sufficiently close to that of the cellulose esters to provide a composition with high transmission and low haze. In one embodiment, the acrylic impact modifiers have a RI that close to the RI of the cellulose ester of about 1.46-1.50 to provide dear compositions. In embodiments, the impact modifier and cellulose ester components have a difference in refractive index, RI(second component)−RI(first component) (e.g., RI of CE−RI of impact modifier), of about 0.006 to about −0.0006, and the immiscible blend has a percent transmittance of at least 75%, and a haze of 10% or less more preferably 5% or less.

In embodiments, the composition further comprising the impact modifier has a percent transmittance of at least 75%, or at least 80%, or at least 85%, or at least 90%, or at least 95%. In one class of this embodiment, the composition further comprising the impact modifier has a percent haze of less than 10%. In embodiments, the composition further comprising the impact modifier has a percent haze of less than 8%, or less than 6%, or less than 5%.

In one embodiment, the impact modifier can be either a non-reactive impact modifier or a reactive impact modifier, or combination of both. It is believed that certain impact modifiers can also improve mechanical and physical properties of the cellulose ester compositions.

In one embodiment, where non-reactive impact modifiers are utilized, the impact modifier contains a first polymeric chain segment that is more chemically or physically compatible with the cellulose ester than another polymeric chain segment. In an embodiment, the first segment contains polar functional groups, which provide compatibility with the cellulose ester, including, but not limited to, such polar functional groups as ethers, esters, amides, alcohols, amines, ketones and acetals. Compatibility is defined by the preferential interaction of the first polymer chain segment with the cellulose ester polymer relative to the second segment and can mean molecular scale or microscale interactions. In one embodiment, the first segment is polyethylenevinyl acetate; polyoxyethylene or polyvinyl alcohol.

In embodiments, the second segment can be either saturated or unsaturated hydrocarbon groups or contain both saturated and unsaturated hydrocarbon groups. The second segment can be an oligomer or a polymer. In one embodiment of the invention, the second segment of the non-reactive impact modifier is selected from the group consisting of polyolefins, polydienes, polyaromatics, and copolymers. An example of a polyaromatic second segment is polystyrene. An example of a copolymer second segment is styrene/butadiene copolymer.

Examples of non-reactive impact modifiers include, but are not limited to, ethoxylated alcohols, ethoxylated alkylphenols, ethoxylated fatty acids, polyethylenevinyl acetate, block polymers of propylene oxide and ethylene oxide, ethylene/propylene terpolymers, functionalized polyolephins, polyglycerol esters, polysaccharide esters, and sorbitan esters. Examples of ethoxylated alcohols are C₁₁-C₁₅ secondary alcohol ethoxylates, polyoxyethylene cetyl ether, polyoxyethylene stearyl ether, and C₁₂-C₁₄ natural liner alcohol ethoxylated with ethylene oxide. C₁₁-C₁₅ secondary ethyoxylates can be obtained as Dow Tergitol® 15S from the Dow Chemical Company. Polyoxyethlene cetyl ether and polyoxyethylene stearyl ether can be obtained from ICI Surfactants under the Brij® series of products. C₁₂-C₁₄ natural linear alcohol ethoxylated with ethylene oxide can be obtained from Hoechst Celanese under the Genapol® series of products. Examples of ethoxylated alkylphenols include octylphenoxy poly(ethyleneoxy)ethanol and nonylphenoxy poly(ethyleneoxy)ethanol. Octylphenoxy poly(ethyleneoxy)ethanol can be obtained as Igepal® CA series of products from Rhodia, and nonylphenoxy poly(ethyleneoxy)ethanol can be obtained as Igepal CO series of products from Rhodia or as Tergitol® NP from Dow Chemical Company. Ethyoxylated fatty acids can include polyethyleneglycol monostearate or monolaruate which can be obtained from Henkel under the Nopalcol® series of products. Block polymers of propylene oxide and ethylene oxide can be obtained under the Pluronic® series of products from BASF. Polyglycerol esters can be obtained from Stepan under the Drewpol® series of products. Polysaccharide esters can be obtained from Henkel under the Glucopon® series of products, which are alkyl polyglucosides. Sorbitan esters can be obtained from ICI under the Tween® series of products.

In another embodiment of the invention, the non-reactive impact modifiers can be synthesized in situ in the cellulose ester composition by reacting cellulose ester-compatible compounds. These compounds can be, for example, telechelic oligomers, which are defined as prepolymers capable of entering into further polymerization or other reaction through their reactive end groups. In one embodiment of the invention, these in situ impact modifiers can have higher molecular weight (weight average molecular weight Mw) from about 10,000 to about 1,000,000.

In another embodiment of the invention, the impact modifier can be reactive. The reactive impact modifier can comprise a polymer or oligomer compatible with one component of the composition and functionality capable of reacting with another component of the composition. In embodiments, there are two types of reactive impact modifiers that can be used. The first reactive impact modifier has a hydrocarbon chain that is compatible with the cellulose ester and also has functionality capable of reacting with the cellulose ester. Such functional groups include, but are not limited to, carboxylic acids, anhydrides, acid chlorides, epoxides, and isocyanates. Specific examples of this type of reactive impact modifier include, but are not limited to: long chain fatty acids, such as, stearic acid (octadecanoic acid); long chain fatty acid chlorides, such as, stearoyl chloride (octadecanoyl chloride); long chain fatty acid anhydrides, such as, stearic anhydride (octadecanoic anhydride); epoxidized oils and fatty esters; styrene maleic anhydride copolymers; maleic anhydride grafted polypropylene; copolymers of maleic anhydride with olefins and/or acrylic esters, e.g. terpolymers of ethylene, acrylic ester and maleic anhydride; and copolymers of glycidyl methacrylate with olefins and/or acrylic esters, e.g. terpolymers of ethylene, acrylic ester, and glycidyl methacrylate.

Reactive impact modifiers can be obtained as SMA® 3000 styrene maleic anhydride copolymer from Sartomer/Cray Valley, Eastman G-3015® maleic anhydride grafted polypropylene from Eastman Chemical Company, Epolene® E-43 maleic anhydride grafted polypropylene obtained from Westlake Chemical, Lotader® MAH 8200 random terpolymer of ethylene, acrylic ester, and maleic anhydride obtained from Arkema, Lotader® GMA AX 8900 random terpolymer of ethylene, acrylic ester, and glycidyl methacrylate, and Lotarder® GMA AX 8840 random terpolymer of ethylene, acrylic ester, and glycidyl methacrylate.

Modified polyolefin impact modifiers can be obtained as Lotader, Fusabond, Elvloy PTW, Lotryl, Elvaloy AC, InterLoy).

The second type of reactive impact modifier has a polar chain that is compatible with the cellulose ester and also has functionality capable of reacting with the cellulose ester. Examples of these types of reactive impact modifiers include cellulose esters or polyethylene glycols with olefin or thiol functionality. Reactive polyethylene glycol impact modifiers with olefin functionality include, but are not limited to, polyethylene glycol allyl ether and polyethylene glycol acrylate. An example of a reactive polyethylene glycol impact modifier with thiol functionality includes polyethylene glycol thiol. An example of a reactive cellulose ester impact modifier includes mercaptoacetate cellulose ester.

In embodiments of the invention, the amount of impact modifier in the cellulose ester composition can range from about 1 wt % to about 30 wt %, or from about 1 wt % to about 15 wt %, or from about 5 wt % to about 10 wt %, or from about 10 wt % to about 30 wt %, or from about 15 wt % to about 30 wt %, based on the weight of the cellulose ester composition.

In another embodiment of the invention, the cellulose ester compositions further comprise at least one additional polymeric component as a blend (with the cellulose ester) in an amount from 5 to 95 weight %, based on the total cellulose ester composition. Suitable examples of the additional polymeric component include, but are not limited to, nylon; polyesters; polyamides; polystyrene; other cellulose esters, cellulose ethers; polystyrene copolymers; styrene acrylonitrile copolymers; polyolephins; polyurethanes; acrylonitrile butadiene styrene copolymers; poly(methylmethacrylate); acrylic copolymers; poly(ether-imides); polyphenylene oxides; polyvinylchloride; polyphenylene sulfides; polyphenylene sulfide/sulfones; poly(ester-carbonates); polycarbonates; polysulfones; poly lactic acid; poly butylenesuccinate; polysulfone ethers; and poly(ether-ketones) of aromatic dihydroxy compounds; or mixtures of any of the foregoing polymers. The blends can be prepared by conventional processing techniques known in the art, such as melt blending or solution blending. In embodiments, the surfaces of the article that are configured to contact a terpene containing plant-based oil composition comprise the cellulose ester compositions (described herein) and less than 10 wt %, or less than 5 wt %, or less than 2 wt %, or no amount of other polymeric materials, e.g., as a blend with the cellulose ester composition.

In one embodiment of the invention, the cellulose ester composition can contain a plasticizer. The plasticizer can be any that is known in the art that can reduce the glass transition temperature and/or the melt viscosity of the cellulose ester to improve melt processing characteristics. The plasticizer may be any plasticizer suitable for use with a cellulose ester. The plasticizer level should be lower than the normal (or typical) plasticizer level for cellulose esters; so that the compositions have higher Tg (or HDT) than fully plasticized cellulose ester compositions, good toughness and good flow. In embodiments, the plasticizer is present in an amount that does not substantially reduce the Tg (or HDT) of the cellulose ester composition compared to a similar composition without the plasticizer. In embodiments, the Tg (or HDT) does not change (e.g., reduce) more than 20%, or 15%, or 10%, or 5%, or 2%, as a result of including the plasticizer.

The plasticizer can be either monomeric or polymeric in structure. In one embodiment, the plasticizer is at least one selected from the group consisting of an aromatic phosphate ester plasticizer, alkyl phosphate ester plasticizer, dialkylether diester plasticizer, tricarboxylic ester plasticizer, polymeric polyester plasticizer, polyglycol diester plasticizer, polyester resin plasticizer, aromatic diester plasticizer, aromatic trimester plasticizer, aliphatic diester plasticizer, carbonate plasticizer, epoxidized ester plasticizer, epoxidized oil plasticizer, benzoate plasticizer, polyol benzoate plasticizer adipate plasticizer, a phthalate plasticizer, a glycolic acid ester plasticizer, a citric acid ester plasticizer, a hydroxyl-functional plasticizer, or a solid, non-crystalline resin plasticizer.

In one embodiment of the invention, the plasticizer can be selected from at least one of the following: triphenyl phosphate, tricresyl phosphate, cresyldiphenyl phosphate, octyldiphenyl phosphate, diphenylbiphenyl phosphate, trioctyl phosphate, tributyl phosphate, diethyl phthalate, dimethoxyethyl phthalate, dimethyl phthalate, dioctyl phthalate, dibutyl phthalate, di-2-ethylhexyl phthalate, butylbenzyl phthalate, dibenzyl phthalate, butyl phthalyl butyl glycolate, ethyl phthalyl ethyl glycolate, methyl phthalyl ethyl glycolate, triethyl citrate, tri-n-butyl citrate, acetyltriethyl citrate, acetyl-tri-n-butyl citrate, and acetyl-tri-n-(2-ethylhexyl) citrate, diethylene glycol dibenzoate, dipropylene glycol dibenozoate, or triethylene glycol dibenzoate.

In another embodiment of the invention, the plasticizer can be selected from at least one of the following: esters comprising: (i) acid residues comprising one or more residues of: phthalic acid, adipic acid, trimellitic acid, succinic acid, benzoic acid, azelaic acid, terephthalic acid, isophthalic acid, butyric acid, glutaric acid, citric acid or phosphoric acid; and (ii) alcohol residues comprising one or more residues of an aliphatic, cycloaliphatic, or aromatic alcohol containing up to about 20 carbon atoms.

In another embodiment of the invention, the plasticizer can be selected from at least one of the following: esters comprising: (i) at least one acid residue selected from the group consisting of phthalic acid, adipic acid, trimellitic acid, succinic acid, benzoic acid, azelaic acid, terephthalic acid, isophthalic acid, butyric acid, glutaric acid, citric acid and phosphoric acid; and (ii) at least one alcohol residue selected from the group consisting of aliphatic, cycloaliphatic, and aromatic alcohol containing up to about 20 carbon atoms.

In another embodiment of the invention, the plasticizer can comprise alcohol residues where the alcohol residues is at least one selected from the following: stearyl alcohol, lauryl alcohol, phenol, benzyl alcohol, hydroquinone, catechol, resorcinol, ethylene glycol, neopentyl glycol, 1,4-cyclohexanedimethanol, and diethylene glycol.

In another embodiment of the invention, the plasticizer can be selected from at least one of the following: benzoates, phthalates, phosphates, arylene-bis(diaryl phosphate), and isophthalates. In another embodiment, the plasticizer comprises diethylene glycol dibenzoate, abbreviated herein as “DEGDB”.

In another embodiment of the invention, the plasticizer can be selected from at least one of the following: aliphatic polyesters comprising C₂₋₁₀ diacid residues, for example, malonic acid, succinic acid, glutaric acid, adipic acid, pimelic acid, suberic acid, azelaic acid, and sebacic acid; and C₂₋₁₀ diol residues.

In another embodiment, the plasticizer can comprise diol residues which can be residues of at least one of the following C₂-C₁₀ diols: ethylene glycol, diethylene glycol, 1,2-propylene glycol, 1,3-propylene glycol, 1,2-butylene glycol, 1,3-butylene glycol, 1,4-butylene glycol, neopentyl glycol, 1,5-pentanediol, 1,6 hexanediol, 1,5-pentylene glycol, triethylene glycol, and tetraethylene glycol.

In another embodiment of the invention, the plasticizer can include polyglycols, such as, for example, polyethylene glycol, polypropylene glycol, and polybutylene glycol. These can range from low molecular weight dimers and trimers to high molecular weight oligomers and polymers. In one embodiment, the molecular weight of the polyglycol can range from about 200 to about 2000.

In another embodiment of the invention, the plasticizer comprises at least one of the following: Resoflex® R296 plasticizer, Resoflex® 804 plastocizer, SHP (sorbitol hexapropionate), XPP (xylitol pentapropionate), XPA (xylitol pentaacetate), GPP (glucose pentaacetate), GPA (glucose pentapropionate) and APP (arabitol pentapropionate).

In another embodiment of the invention, the plasticizer comprises one or more of: A) from about 5 to about 95 weight % of a C₂-C₁₂ carbohydrate organic ester, wherein the carbohydrate comprises from about 1 to about 3 monosaccharide units; and B) from about 5 to about 95 weight % of a C₂-C₁₂ polyol ester, wherein the polyol is derived from a C₅ or C₆ carbohydrate. In one embodiment, the polyol ester does not comprise or contain a polyol acetate or polyol acetates.

In another embodiment, the plasticizer comprises at least one carbohydrate ester and the carbohydrate portion of the carbohydrate ester is derived from one or more compounds selected from the group consisting of glucose, galactose, mannose, xylose, arabinose, lactose, fructose, sorbose, sucrose, cellobiose, cellotriose and raffinose.

In another embodiment of the invention, the plasticizer comprises at least one carbohydrate ester and the carbohydrate portion of the carbohydrate ester comprises one or more of α-glucose pentaacetate, β-glucose pentaacetate, α-glucose pentapropionate, β-glucose pentapropionate, α-glucose pentabutyrate and β-glucose pentabutyrate.

In another embodiment, the plasticizer comprises at least one carbohydrate ester and the carbohydrate portion of the carbohydrate ester comprises an α-anomer, a β-anomer or a mixture thereof.

In another embodiment, the plasticizer can be selected from at least one of the following: propylene glycol dibenzoate, glyceryl tribenzoate, diethylene glycol dibenzoate, triethylene glycol dibenzoate, di propylene glycol dibenzoate, and polyethylene glycol dibenzoate.

In another embodiment of the invention, the plasticizer can be a solid, non-crystalline resin. These resins can contain some amount of aromatic or polar functionality and can lower the melt viscosity of the cellulose esters. In one embodiment of the invention, the plasticizer can be a solid, non-crystalline compound (resin), such as, for example, rosin; hydrogenated rosin; stabilized rosin, and their monofunctional alcohol esters or polyol esters; a modified rosin including, but not limited to, maleic- and phenol-modified rosins and their esters; terpene resins; phenol-modified terpene resins; coumarin-indene resins; phenolic resins; alkylphenol-acetylene resins; and phenol-formaldehyde resins.

In another embodiment of the invention, the plasticizer is at least one plasticizer selected from the group consisting of: triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate, di-octyl adipate, dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, tribenzoin, polycaprolactone, glycerin, glycerin esters, diacetin, glycerol acetate benzoate, polyethylene glycol, polyethylene glycol esters, polyethylene glycol diesters, di-2-ethylhexyl polyethylene glycol ester, triethylene glycol bis-2-ethyl hexanoate, glycerol esters, diethylene glycol, polypropylene glycol, polyglycoldiglycidyl ethers, dimethyl sulfoxide, N-methyl pyrollidinone, C1-C20 dicarboxylic acid esters, dimethyl adipate, di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, γ-valerolactone, alkylphosphate esters, aryl phosphate esters, phospholipids, eugenol, cinnamyl alcohol, camphor, methoxy hydroxy acetophenone, vanillin, ethylvanillin, 2-phenoxyethanol, glycol ethers, glycol esters, glycol ester ethers, polyglycol ethers, polyglycol esters, ethylene glycol ethers, propylene glycol ethers, ethylene glycol esters, propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, diethylene glycol dibenzoate, dipropylene glycol dibenozoate, triethylene glycol dibenzoate, butylated hydroxytoluene, butylated hydroxyanisol, sorbitol, xylitol, ethylene diamine, piperidine, piperazine, hexamethylene diamine, triazine, triazole, pyrrole, and any combination thereof.

The amount of plasticizer in the cellulose ester composition can range from 0 to about 15 weight percent based on the weight of the cellulose ester composition. In one embodiment, the amount can range up to about 15 weight percent based on the weight of the cellulose ester composition. In another embodiment, the amount can range up to about 10 weight percent based on the weight of the cellulose ester composition. In another embodiment, the amount can range up to about 5 weight percent based on the weight of the cellulose ester composition, or up to about 3 weight percent based on the weight of the cellulose ester composition, or less than 2 weight percent based on the weight of the cellulose ester composition.

In another embodiment of the invention, the composition contains no plasticizer. In one embodiment, the cellulose ester composition comprises a cellulose ester that is CAP and no plasticizer. In one embodiment, the cellulose ester composition comprises a cellulose ester that is CAB and no plasticizer.

In another embodiment, the cellulose ester composition is melt processable. Melt processability generally refers to the ability to thermally process the materials below their degradation temperature to obtain homogeneous pellets and the plastic articles. For example, the compositions described can be melt extruded on a Werner & Pflerderer 30 mm twin screw extruder at a throughput of 35 lbs/hour with screw speed of 250 rpm and barrel temperature of 240° C. injection molded on a Toyo 110 injection molding machine with barrel temperature of 240° C. and mold temperature of 160° F. with minimal molecular weight or color degradation.

In one embodiment of this invention, a melt processable cellulose ester composition is provided comprising 1 to 30 wt %, or 1 to 15 wt %, or 2 to 10 wt % of impact modifiers and no plasticizer, the cellulose ester composition having a heat deflection temperature (HDT) value of greater than 95° C. (measured according to ASTM D648 at a 1.82 MPa stress level after conditioning for 4 hours at 70° C.), and notched Izod impact strength value of greater than 80 J/m (measured according to ASTM D256 on 3.2 mm thick bars at 23° C.), and spiral flow values of at least 15 inches at 240 C when measured using the procedure described herein. In one embodiment, the cellulose ester composition has a Tg value measured at 20 C/min according to ASTM D3418 of greater than 120° C.

In another embodiment of the invention, the compositions have a melt viscosity at 240° C. and 400 rad/s of 10,000 1/s or below measured by a plate-plate melt rheometer such as aRheometrics Dynamic Analyzer (RDA II) with 25 mm diameter parallel plates, 1 mm gap and 10% strain measured in accordance with ASTM D4440 using frequency scan of between 1 rad/sec and 400 rad/sec.

In one embodiment. the melt processable cellulose ester compositions comprise 0 to 30 wt %, or 0 to 15 wt % of impact modifiers, 0 to 15 wt % of plasticizers, and have a Tg greater than 90° C. In another embodiment, the melt processable cellulose ester compositions comprise 0 to 30 wt %, or 0 to 15 wt % of impact modifiers, 0 to 10 wt % of plasticizers, and have a Tg greater than 100° C. In yet another embodiment, melt processable cellulose ester compositions comprise 0 to 10 wt % of impact modifiers, 0 to 10 wt % of plasticizers, and have a Tg greater than 100° C. In another embodiment, melt processable cellulose ester compositions comprise 0 to 10 wt % of impact modifiers, 0 to 5 wt % of plasticizers, and have a Tg greater than 115° C.

In another embodiment of the invention, the cellulose ester compositions have a Tg or Heat deflection temperature (HDT at 0.455 psi) similar to that of the base cellulose ester polymer with a drop of only a few degrees Celsius (e.g., less than 5° C., or less than 2° C.) with the incorporation of an impact modifier and no plasticizer. Impact properties of these composition can also exceed 80 J/m (notched Izod impact strength at 23° C.).

In embodiments of the invention, the polymer-based resin has a heat distortion temperature (“HDT”) greater than 90° C., or greater than 95° C., according to ASTM D648 as measured at 1.82 MPa using a 3.2 mm thick bar that was subjected to 70° C. for 4 hours. In certain embodiments, the polymer-based resin has a heat distortion temperature (“HDT”) of at least 95° C., at least 100° C., at least 105° C., or at least 110° C., or at least 115° C. In certain embodiments, the polymer-based resin has a heat distortion temperature (“HDT”) in the range from 90° C. to 140° C., 90° C. to 130° C., 90° C. to 120° C., 90° C. to 110° C., 95° C. to 140° C., 95° C. to 130° C., 95° C. to 120° C., 95° C. to 110° C., 95° C. to 105° C., 100° C. to 140° C., 100° C. to 130° C., 100° C. to 120° C., 100° C. to 110° C., 105° C. to 140° C., 105° C. to 130° C., 105° C. to 120° C., 105° C. to 115° C., 105° C. to 110° C., 110° C. to 140° C., 110° C. to 130° C., 110° C. to 125° C., 110° C. to 120° C., 110° C. to 115° C., 115° C. to 140° C., 115° C. to 130° C., 120° C. to 140° C., 120° C. to 130° C., or 120° C. to 125° C.

In embodiments of the invention, the polymer-based resin has a notched izod impact strength of at least 80 J/m, or at least 90 J/m, or at least 100 J/m, or at least 110 J/m, or at least 120 J/m, or at least 130 J/m, or at least 140 J/m, or at least 150 J/m, or at least 160 J/m, or at least 170 J/m, or at least 180 J/m, or at least 190 J/m, or at least 200 J/m, as measured according to ASTM D256 using a 3.2 mm thick bar that has been subjected to 50% relative humidity for 48 hours at 23° C. In certain embodiments, the polymer-based resin has a notched izod impact strength in the range of from about 80 J/m to about 500 J/m, from about 80 J/m to about 400 J/m, from about 80 J/m to about 300 J/m, from about 80 J/m to about 200 J/m, from about 100 J/m to about 500 J/m. from about 100 J/m to about 400 J/m, from about 100 J/m to about 300 J/m, from about 100 J/m to about 200 J/m, from about 120 J/m to about 500 J/m, from about 120 J/m to about 400 J/m, from about 120 J/m to about 300 J/m, from about 120 J/m to about 200 J/m, from about 150 J/m to about 500 J/m, from about 150 J/m to about 400 J/m, from about 150 J/m to about 300 J/m, from about 150 J/m to about 200 J/m, from about 170 J/m to about 500 J/m, from about 170 J/m to about 400 J/m, from about 170 J/m to about 300 J/m, from about 170 J/m to about 200 J/m, from 180 J/m to about 500 J/m, from about 180 J/m to about 400 J/m, from about 180 J/m to about 300 J/m, from about 180 J/m to about 200 J/m, from 190 J/m to about 500 J/m, from about 190 J/m to about 400 J/m, from about 190 J/m to about 300 J/m, from about 190 J/m to about 200 J/m, from 200 J/m to about 500 J/m, from about 200 J/m to about 400 J/m, or from about 200 J/m to about 300 J/m, as measured according to ASTM D256 using a 3.2 mm thick bar that has been subjected to 50% relative humidity for 48 hours at 23° C.

In another embodiment of the invention, the cellulose ester compositions further comprise at least one additive selected from the group comprising antioxidants, thermal stabilizers, mold release agents, antistatic agents, whitening agents, colorants, flow aids, processing aids, plasticizers, anti-fog additives, minerals, UV stabilizers, lubricants, chain extenders, nucleating agents, reinforcing fillers, wood or flour fillers, glass fiber, carbon fiber, flame retardants, dyes, pigments, colorants, additional resins and combinations thereof.

In embodiments, mixing of the impact modifiers, cellulose esters, and the optional plasticizers and any additives can be accomplished by any method known in the art that is adequate to disperse the impact modifiers, plasticizers and additives into the cellulose esters. Examples of mixing equipment include, but are not limited to, Banbury mixers, Brabender mixers, roll mills, and extruders (single or twin screw). The shear energy during the mixing is dependent on the combination of equipment, blade design, rotation speed (rpm), and mixing time. The shear energy should be sufficient to disperse the impact modifier throughout the cellulose ester.

In embodiments, the cellulose ester, impact modifier, plasticizer and additives can be combined in any order during the process. In one embodiment, the cellulose ester is premixed with the impact modifier and/or the plasticizer. The cellulose ester containing the impact modifier and/or the plasticizer is then mixed with the additives. In another embodiment of the invention, when reactive impact modifiers are utilized, the reactive impact modifiers can be mixed with the cellulose esters first, and then the other components are added.

In certain embodiments of the invention, the cellulose ester compositions contain 2 wt %-15 wt % impact modifier, based on the total weight of the cellulose ester composition, and have HDT values greater than 95 C, and notched Izod impact strength values greater than 80 J/m, and viscosities at 240 C and 400 rad/sec greater than 10,000 P.

In another embodiment, cellulose ester compositions are provided that have a total DS/AGU in the range from about 2 to about 2.99 and the DS/AGU of acetyl ranges from about 0 to about 2.2, with the remainder of the ester groups comprising propionyl, butyryl or combinations thereof.

In other embodiments, the melt processable cellulose ester compositions described above, optionally contain some plasticizer. In embodiments, the plasticizer is present in an amount that does not substantially reduce the HDT of the cellulose ester composition compared to a similar composition without the plasticizer. In embodiments, the HDT does not change (e.g., reduce) more than 10%, or 5%, or 2%, as a result of including the plasticizer.

In one aspect, an article is provided that comprises a molded component configured to receive a terpene containing oil composition, where the molded component is formed of a plastic composition comprising cellulose ester and having an HDT of at least 95° C.

The terpene containing oil composition contains a terpene containing oil in an amount of at least 1 wt %, or at least 5 wt %, or at least 10 wt %, or at least 15 wt % or at least 20 wt %, or at least 25 wt %. Terpene containing oil means an oil that contains at least one terpene compound in an amount of at least 0.1 wt % based on the weight of the oil. In embodiments, the terpene containing oil composition contains at least 0.01, or at least 0.05, or at least 0.1, or at least 0.5, or at least 1, or at least 5, or at least 10 wt % of total terpene compounds.

In embodiments, the terpene containing oil is a terpene containing plant-based oil. Terpene containing plant-based oil means a type of oil that can be found in or obtained from plants and that comprises at least one terpene. The definition of plants is not to be limited and can include any type or classification of plants, including vascular, non-vascular, seed bearing, spore bearing, angiosperms, and gymnosperms. Plants can include small plants, bushes, or trees. In embodiments, the terpene containing plant-based oil can be synthesized or made without the oil actually being derived from plants, as long as the oil is of a type that can be found in or obtained from plants.

In embodiments, the terpene containing plant-based oil is a type found primarily in the leaves or flowers of a plant. In embodiments, the terpene containing plant-based oil is a type found primarily in the seeds or fruit of a plant. In embodiments, the terpene containing oil composition can be a combination (e.g., mixture or blend) of different plant-based oils with the proviso that the composition comprises at least one terpene containing plant-based oil.

In embodiments, the terpene containing oil composition comprises a plant-based oil. In embodiments, the plant-based oil is a botanical oil. Botanical oil means an oil of a type obtained from plants that are fatty, dense and non-volatile. In embodiments, the botanical oil is extracted from the root, stem/bark, leaves, flowers, seeds or fruit of a plant, tree or shrub. In embodiments, the botanical oil is cold pressed or extracted by heat. Examples of botanical oils can include rosehip oil (rosa canina), evening primrose oil (oenothera biennis), almond oil (prunus amygdalus dulcis), calendula oil (calendula officinalis), MCT oil, olive oil, canola oil, corn oil, vegetable oil, cotton seed oil, safflower oil, sunflower seed oil, soapbark tree oil; and extracts, isolates, or derivatives of the foregoing; and combinations of any of the foregoing.

In embodiments, the plant-based oil is an essential oil. Essential oil means a concentrated and volatile substance extracted from plants chosen from aromatic herbs or aromatic plants, where essential refers to an oil that carries a distinctive scent (or essence) of such a plant. Examples of essential oils can include agar oil or oodh, aiwain oil, angelica root oil, anise oil, asafetida oil, balsam of perp, basil oil, bay oil, bergamot oil, black pepper oil, buchu oil, birch oil, camphor oil, cannabis flower essential oil, calamodin oil or calamansi essential oil, caraway seed oil, cardamom seed oil, carrot seed oil, cedar oil, chamomile oil, calamus oil, cinnamon oil, cistus ladanifer, citron oil, citronella oil, clary sage oil, coconut oil, clove oil, coffee oil, coriander oil, costmary oil, costus root oil, cranberry seed oil, cubeb oil, cumin seed oil or black seed oil, cypress oil, cypriol oil, curry leaf oil, davana oil, dill oil, elecampane oil, elemi oil, eucalyptus oil, fennel seed oil, fenugreek oil, fir oil, frankincense oil, galangal oil, galbanum oil, garlic oil, geranium oil, ginger oil, goldenrod oil, grapefruit oil, henna oil, helichrysum oil, hickory nut oil, horseradish oil, hyssop, Idaho-grown tansy, jasmine oil, juniper berry oil, laurus nobilis, lavender oil, ledum oil, lemon oil, lemongrass oil, lime oil, listea cubeba oil, linalool oil, mandarin oil, marjoram oil, melissa oil or lemon balm, mentha arvensis oil or mint oil, moringa oil, mountain savory oil, mugwort oil, mustard oil, myrrh oil, myrtle oil, neem oil, neroli oil, nutmeg oil, orange oil, oregano oil, orris oil, pale santo oil, parsley oil, patchouli oil, perilla essential oil, pennyroyal oil, peppermint oil, petitgrain oil, pine oil, ravensara oil, red cedar oil, romain chamomile oil, rose oil, rosehip oil, rosemary oil, rosewood oil, sage oil, sandalwood oil, sassafras oil, savory oil, Schisandra oil, spearmint oil, spikenard oil, spruce oil, star anise oil, tangerine oil, tarragon oil, tea tree oil, thyme oil, tsuga oil, turmeric oil, warionia oil, vetiver oil, western red cedar oil, wintergreen oil, yarrow oil, ylang-ylang oil; and extracts, isolates, or derivatives of the foregoing; and combinations of any of the foregoing. In embodiments, the extract, isolate or derivative of the essential oil comprises a terpene or a flavonoid. In embodiments, the terpene is chosen from d-limonene, geraniol, b-pinene, myrcene, terpinolene, or mixtures thereof.

In embodiments, the plant-based oil can be a combination of one or more botanical oils and one or more essential oils. In embodiments, the terpene containing oil composition comprises a terpene containing plant-based oil component, where the terpene containing plant-based oil component comprises one or more terpene containing plant-based oils chosen from a botanical oil, an essential oil, or combinations of botanical and essential oils. Examples of terpene containing plant-based oils include eucalyptus oil, lavender oil, neroli oil, cannabis oil, hemp oil, cannabidiol oil, peppermint oil, sweet orange oil, tea tree oil, lemon oil, lime oil, orange oil; and extracts, isolates, or derivatives of the foregoing oils and/or their plant source; and combinations of any of the foregoing.

In embodiments, the terpene containing oil composition comprises a terpene containing plant-based oil component and a terpene free plant-based oil component, where the terpene containing plant-based oil component comprises one or more terpene containing plant-based oils and the terpene free plant-based oil component comprises one or more plant-based oils that do not contain a terpene.

In embodiments, the polymer-based resin forming the injection molded article is chosen from any of the cellulose ester compositions discussed herein. In one embodiment, the resin is a cellulose ester composition comprising CAP, a secondary antioxidant, and an acid scavenger, and having an HDT greater than 95° C. In one embodiment, this cellulose ester composition further comprises 1 to 30 wt % of an impact modifier, less than 2 wt % of a plasticizer, or no plasticizer, and less than 5 wt %, or less than 2 wt % of any other additives.

Properties disclosed herein requiring a test method can be determined as follows:

### Test Methods

Properties disclosed throughout this application can be determined according to the test methods described herein. Samples were (or can be) evaluated using standard ASTM test methods with any special conditions noted below.

TABLE 1
Test Methods

| PROPERTY | COMMENTS |
|---|---|
| Color, b* (ASTM E1348) | Using 3.2 mm thick plaques. Measured |
| | using Hunter Lab Ultrascan Spectra |
| | Colorimeter |
| Color, a* (ASTM E1348) | Using 3.2 mm thick plaques. Measured |
| | using Hunter Lab Ultrascan Spectra |
| | Colorimeter |
| Color, L* (ASTM E1348) | Using 3.2 mm thick plaques. Measured |
| | using Hunter Lab Ultrascan Spectra |
| | Colorimeter |
| Haze (ASTM D1003) | Using 3.2 mm plaques |
| Transmission (ASTM D1003) | Using 3.2 mm plaques |
| Δ M_{w} % (GPC) | % Change in Absolute Weight Average |
| | Molecular Weight From Pellet To |
| | Plaque or Test Bar Based On Pellet |
| | Absolute Molecular Weight |
| Izod Notched Impact at | Using a 0.32 mm thick bar that has |
| 23° C. (ASTM D256) | been subjected to 50% relative |
| | humidity at 23° C. for 48 hours. |
| HDT 1.82 MPa (ASTM D648) | Using a 0.32 mm thick bar subjected |
| | to 70° C. for 4 hours. |
| Flexural Modulus (ASTM D790) | Using a 1.3 cm × 12.7 cm × 0.3 mm |
| | bar subjected to 50% Relative |
| | humidity for 48 hours at 23° C. |
| Absolute Weight Average | Using tetrahydrofuran stabilized |
| Molecular Weight (ASTM | with BHT as a solvent and a flow |
| D5296) | rate of 1 mL/min. |

Spiral Row

3.2 mm Thick Bar

A reciprocating screw injection molding machine having 110 tons of damping force with a screw diameter of 32 mm was equipped with a water-cooled, cold runner mold with a spiral-shaped cavity having dimensions of 0.50″ wide×0.125″ deep×60.00″ in length. The cavity was fed via a 3.5″ long cold sprue with a nominal 0.400″ diameter and 3-degree taper, followed by a 1.0 long cold runner with 0.30″ nominal diameter, followed by a rectangular gate 0.25″ wide×0.050″ thick×0.10″ long. Variables controlled for the range of experimentation included resin drying, injection unit barrel temperature, mold temperature, initial injection speed, injection pressure limit, screw rotation speed and back pressure on screw recovery, injection time, and cycle time.

For each combination of variables, responses included actual melt temperature and distance of melt travel in the spiral-shaped cavity, excluding the runner and gate. The injection process was allowed to stabilize at each set of conditions—typically 10 to 15 shots—and then 10 molded specimens were collected for an average reported flow length.

All materials were molded using pressure control, with mold temperature of 80 F, initial injection speed of 1 in/s, injection unit pressure limit of 1000 psi, injection time of 10 s, cycle time of 38 s, maximum cushion of 0.1″, screw recovery rotation speed of 150 rpm, and screw recovery back pressure of 100 psi.

0.8 mm Thick Bar

A reciprocating screw injection molding machine having 110 tons of clamping force with a screw diameter of 32 mm was equipped with a water-cooled, cold runner mold with a spiral-shaped cavity having dimensions of 0.50″ wide×0.030″ deep×60.00″ in length. The cavity was fed via a 3.5″ long cold sprue with a nominal 0.400″ diameter and 3-degree taper, followed by a 1.0″ long cold runner with 0.30″ nominal diameter, followed by a rectangular gate 0.25″ wide×0.030″ thick×0.10″ long. Variables controlled for the range of experimentation included resin drying, injection unit barrel temperature, mold temperature, initial injection speed, injection pressure limit, screw rotation speed and back pressure on screw recovery, injection time, and cycle time.

For each combination of variables, responses included actual melt temperature and distance of melt travel in the spiral-shaped cavity, excluding the runner and gate. The injection process was allowed to stabilize at each set of conditions—typically 10 to 15 shots—and then 10 molded specimens were collected for an average reported flow length.

All materials were molded using pressure control, with mold temperature of 120° F. (49° C.), initial injection speed of 1 in/s, injection unit pressure limit of 2000 psi, injection time of 5 s, cycle time of 32 s, maximum cushion of 0.2″, screw recovery rotation speed of 150 rpm, and screw recovery back pressure of 100 psi.

### Abbreviations

Ex is example(s); CA is cellulose acetate; CAB is cellulose acetate butyrate; CAP is cellulose acetate propionate; % H is percent haze; % T is percent transmission; M_{w} is absolute weight average molecular weight, ΔM_{w} % is change in absolute weight average molecular weight; % H is percent haze; RH is relative humidity; ° C. is Degree(s) Celsius; min is minute(s); ° F. is Degree(s) Fahrenheit; Comp. Ex. is comparative example; Pz is plasticizer; Antiox. is antioxidant; SNMO is AKCROSTAB SN-MO; Temp. is temperature; min is minute; NPPP is WESTON Neopentylphenylphosphite; Prim. Is primary; IM is impact modifier; Scav. is scavenger; Stab. Is stabilizer; CE is cellulose ester; oz is ounce; in/sec is inch/second; sec or s is second(s); psi is pounds per square inch; BSP is barrel set point; RT is residence time.

This invention can be further illustrated by the following examples of preferred embodiments thereof, although it will be understood that these examples are included merely for purposes of illustration and are not intended to limit the scope of the invention unless otherwise specifically indicated.

### EXAMPLES

This invention can be further illustrated by the following examples of embodiments thereof. These examples are included merely for purposes of illustration and are not intended to limit the scope of the invention unless otherwise specifically indicated.

### Example 1

The test materials used for example 1 were a copolyester product (TRITAN™ copolyester TX1001 from Eastman Chemical Company), a polycarbonate product (MAKROLON polycarbonate 2658 from Covestro), and a CAP product (Trēva cellulose ester GC6021 from Eastman Chemical Company).

### Test Bar Production

Pellets of each material were injection molded to form standard test bars 0.5 inch×5 inch×0.125 inch (1.27 cm×12.7 cm×0.3 cm). The pellets were molded in A 110 Ton Toyo injection molding machine with barrel capacity 3.4 oz. The CAP material was injection molded at 1 in/sec injection speed into four test bars per shot with barrel temperature nominally of about 249° C. (480° F.) and mold temperature of about 80° C.

### Test Results

ESCR—Property Retention in Reverse Side Impact

Testing was conducted using injection molded flex bars with length, width, and thickness of 5.0″, 0.5″, and 0.125″, respectively. Bars were conditioned at 23° C./50% RH for a minimum of 72 hr. Bars were clamped into a constant strain fixture or a 3-point bend fixture at 1.5% strain and exposed to test oil using a cotton pad saturated with the test oil, where the pad was placed on the top surface of the bar. After the test oils were applied to the bars on the side without ejector pin marks, the strain fixtures with bars attached were sealed in polyethylene bags for 24 hours at nominal temperature of 23° C., after which the bars were wiped clean and removed from the strain fixture.

After exposure, the bars were tested at 23° C. for reverse-side impact. The test apparatus was a CEAST Pendulum Impact Tester equipped with a 15-Joule hammer. Bars were positioned in a 2-inch span fixture, with the non-chemically exposed side facing the hammer. Control bars (exposed to water) were impact tested in addition to bars that were exposed to the test oils. The comparison of results between the controls and the chemically exposed bars was used to calculate percent retention of original impact energy. The results are shown below in Table 2.

TABLE 2
Percent Retention of Reverse-side Impact Strength After Exposure

| Oil | Copolyester | Polycarbonate | Cellulose Ester |
|---|---|---|---|
| d-Limonene | 13 | 17 | 89 |
| Geraniol | 31 | 10 | 88 |
| b-Pinene | 73 | 35 | 94 |
| Myrcene | 16 | 25 | 90 |
| Terpinolene | 12 | 13 | 91 |

A review of Table 2 reveals that the cellulose ester material outperforms polycarbonate in resistance to all oils in this test by a wide margin, With only one exception it also outperforms the copolyester by a wide margin with the copolyester showing a somewhat significant level of resistance to b-Pinene.

### Example 2

ESCR—Property Retention in Tensile Test

Testing was conducted using injection molded tensile bars with length, center width, and thickness of 8.5″, 0.5″, and 0.125″, respectively. Bars were conditioned at 23° C./50% RH for a minimum of 72 hr. Bars were clamped into a constant strain fixture at 1.5% strain and exposed to chemical reagents similar to Example 1, per ASTM method D543. After the reagents were applied to the bars on the side without ejector pin marks, the strain fixtures with bars attached were sealed in polyethylene bags for 24 hours at nominal temperature of 23° C., after which the bars were wiped clean and removed from the strain fixture.

Bars were tested at 23° C. for tensile properties within 24-96 hours after removal from the strain fixture. The test apparatus was an Instron Tensile Tester equipped with a 10 kN load cell. Bars were positioned in the grips with a 4.5″ span between the grips and pulled at 0.2 in/min for the first 0.03 inches, and at 2.0 in/min for the remainder of the pull to break. Control bars (no strain, no chemical exposure) were tensile tested in addition to bars that were chemically exposed. The comparison of results between the controls and the chemically exposed bars was used to calculate percent retention of original break strength and break elongation. The results are shown below in Table 3.

TABLE 3
Percent Retention of Tensile Elongation After Exposure

| Chemical | Copolyester | Polycarbonate | Cellulose Ester |
|---|---|---|---|
| Propylene Glycol | 88 | 98 | 122 |
| Vegetable Glycerin | 90 | 96 | 108 |
| Terpene Mixture* | 51 | 10 | 96 |

*1% limonene in propylene glycol/vegetable glycerin (1:3) mixed solvent

A review of Table 3 reveals that the cellulose ester material outperforms the copolyester and polycarbonate in resistance to the propylene glycol and vegetable glycerin. Further the cellulose ester shows exceptional resistance compared to the other plastics when a typical terpene (limonene in this example) is added to a propylene glycol/vegetable glycerin mixture (row three in Table 2). Terpenes are widely used to add flavor and fragrance to vapor mixtures that may also include other components such as propylene glycol and/or vegetable glycerin. Thus, it would be beneficial for plastics used in vapor delivery devices to be resistant to such chemical mixtures.

Other embodiments will be apparent to those skilled in the art from consideration of the specification and practice of the embodiments disclosed herein. It will be understood that variations and modifications can be affected within the spirit and scope of the disclosed embodiments. It is further intended that the specification and examples be considered as exemplary only, with a true scope and spirit of the disclosed embodiments being indicated by the following claims.

1. An article comprising a molded component configured to receive a terpene containing oil composition, said molded component formed of a plastic composition comprising cellulose ester and having an HDT of at least 95° C.

2. The article according to claim 1, wherein the plastic composition has an HDT in the range from 95° C. to 140° C.

3. The article according to claim 2, wherein the plastic composition has an HDT in the range from 100° C. to 140° C.

4. The article according to claim 1, wherein the plastic composition has a bio-derived content in the range from 20 wt % to 60 wt %.

5. The article according to claim 1, wherein the plastic composition contains less than 4 wt % of a plasticizer.

6. The article according to claim 1, wherein the plastic component comprises a cellulose ester chosen from CA, CAP, CAB or CAIB.

7. The article according to claim 6, wherein the cellulose ester is CAP.

8. The article according to claim 7, wherein the plastic composition comprises CAP and contains no plasticizer.

9. The article according to claim 1, comprising a terpene containing oil composition in contact with a surface of said molded component.

10. The article according to claim 9, wherein the terpene containing oil composition is in the form of a pre-vapor formulation and/or a vapor.

11. The article according to claim 1, wherein the terpene containing oil composition comprises at least 1 wt % of a terpene containing oil.

12. The article according to claim 1, wherein the molded component comprises a container configured to contain a terpene containing oil composition and selectively release the terpene containing oil composition.

13. The article according to claim 12, wherein the molded component comprises a container configured to contain a terpene containing oil composition that is in a pre-vapor formulation form.

14. The article according to claim 1, wherein the molded component comprises a conduit configured to convey a terpene containing oil composition.

15. The article according to claim 14, wherein the molded component comprises a conduit configured to convey a terpene containing oil composition that is in a vapor form.

16. The article according to claim 15, wherein the article comprises one or more molded components that comprise a container configured to contain a terpene containing oil composition and a conduit configured to convey a terpene containing oil composition, wherein the container and conduit are in fluid communication.

17. The article according to claim 1, wherein the article is a vapor delivery device configured to deliver a vapor comprising a terpene containing oil composition.

18. The article according to claim 17, wherein the vapor delivery device is chosen from a vaporizer, nebulizer, humidifier, air freshener, or hand-held vapor delivery device.

19. The article according to claim 1, wherein the molded component can be chosen from injection molded articles, extrusion molded articles, rotational molded articles, compression molded articles, blow molded articles, injection blow molded articles, injection stretch blow molded articles, extrusion blow molded articles, sheet or film extrusion articles, profile extrusion articles, gas assist molding articles, structural foam molded articles, or thermoformed articles.

20. The article according to claim 1, wherein the plastic composition has a reverse-side impact strength retention of at least 80% after exposure to a terpene oil, when tested according to the methods disclosed in Example 1 and/or has a reverse-side impact strength retention of at least 85% after exposure to d-limonene, when tested according to the methods disclosed in Example 1.
